(19) United States
(12) Patent Application Publication
(10) Pub. No.: US 2005/0282559 A1
(43) Pub. Date: Dec. 22, 2005

(54) Method and system for providing supervisory control over wireless phone data usage

(75) Inventors: Thomas Erskine, Marblehead, MA (US); Kenneth W. Sonberg, Andover, MA (US); Luther Rudisill, Parker, TX (US); Dennis E. Turri, Burlington, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Boston Communications Group, Inc.

(21) Appl. No.: 11/153,718

(22) Filed: Jun. 15, 2005

Related U.S. Application Data
(63) Continuation-in-part of application No. 10/784,611, filed on Feb. 23, 2004.
(60) Provisional application No. 60/449,907, filed on Feb. 25, 2003.
(60) Provisional application No. 60/579,854, filed on Jun. 15, 2004.

(51) Int. Cl. H04Q 7/20

(52) U.S. Cl. 455/456.4

(57) ABSTRACT

A system for controlling wireless phone usage enables a supervisor to establish user profiles for supervised users of wireless phones across a range of parameters, which are stored in a user profile database. Such parameters can include one or more locations, at which use of the wireless phone is restricted or permitted. In addition, restrictions on phone use, such as cumulative usage time, number of messages or number of bytes, can be provided based upon total phone usage within a specified control period, time periods, dates or days of the week during which phone use is restricted or permitted. One or more lists including numbers or other identifiers that are always-accessible can be provided, and one or more lists including numbers or other identifiers that are never-accessible can also be provided. In the event a call, message or browse does not satisfy predefined criteria, the communication attempt is blocked. Predetermined messages can be played or displayed to the called or calling party, as applicable, when a communication attempt is blocked. Boolean combinations of restrictions and permissive use criteria for the wireless phone can be specified to provide for flexibility when establishing use criteria for the wireless phone.

### CROSS REFERENCE TO RELATED APPLICATIONS

This application is a continuation-in-part of U.S. patent app. Ser. No. 10/784,611, titled “Method and System for Exercising Supervisory Control Over Wireless Phone Usage,” filed Feb. 23, 2004, which claims priority of U.S. Provisional Pat. App. No. 60/449,907, titled “Method and System for Exercising Supervisory Control Over Wireless Phone Usage,” filed Feb. 25, 2003; and this application claims priority of U.S. Provisional Pat. App. No. 60/579,854, titled “Method and System for Exercising Supervisory Control Over Wireless Phone Usage,” filed Jun. 15, 2004.

### BACKGROUND OF THE INVENTION

The present invention generally relates to wireless communication systems and more specifically to a method and system for providing supervisory control over wireless phone data usage.

Wireless phones are widely used in this country. Wireless phone service providers typically allow a wireless phone subscriber to place calls send and receive text or multimedia messages, browse the Internet, etc. at any time. For reasons of safety and convenience, more and more parents are inclined to have their children of school age carry wireless phones to make it easier for their children to contact them and vice versa. It has also been observed, however, that many children that are provided wireless phones tend to spend inordinate amounts of time on calls to friends during school days and late into evenings, during homework time and at other inappropriate times or in an inappropriate places and that the availability of wireless text messaging, Internet browsing, file downloading and the like can present a distraction during the school day. Presently available wireless phone systems provide no way to adequately provide supervisory control of wireless phone usage by others, e.g. children.

Accordingly, it would be desirable to have a method and system by which supervisory control can be exercised, such as by parents, over wireless phone usage. It would further be desirable to be able to establish a user profile for wireless phone service on a user-by-user basis, without intervention by a telephone service provider. Moreover, it would be desirable to allow a supervisor to modify the user profile as circumstances warrant, without requiring human intervention by the telephone service provider, so as to allow a supervisor to readily change the nature of the wireless service available to supervised individuals.

### BRIEF SUMMARY OF THE INVENTION

In accordance with the present invention, a method and system for exercising supervisory control over wireless data usage is disclosed. Wireless data usage includes, without limitation, text messaging, chat, multimedia messaging, Internet browsing, file downloading and uploading, audio, video or other media streaming and other packet data transfers. The disclosed system allows a Supervisor, such as a parent or manager, to establish individual profiles for supervised Users of respective wireless phones across a range of parameters. For example, a parent can establish a user profile for each child that is to be provided a wireless phone. The user profile allows the use of the phone by the child, subject to controls over data usage, as specified by the Supervisor. For example, the disclosed system allows the Supervisor to limit the number of text messages sent and/or received during a specified control period, such as a week or a month, to a predetermined maximum number of messages and/or kilobytes and to prevent incoming and/or outgoing messages during specified periods, such as during school hours, except from and/or to predetermined numbers or addresses (collectively “always-accessible addresses” or “always-accessible identifiers”) specified by the Supervisor. The Supervisor may be the subscriber who ordered and pays for the wireless service, as may be the situation in the case of a parent supervisor. The Supervisor can also be the user of the phone, as in the case of a self-supervised user. Alternatively, the Supervisor may be a person, such as a manager in a corporation, who oversees wireless phone usage by employees, but who is not the subscriber of record, from the perspective of the wireless carrier. The actual subscriber can be the Supervisor, the user of the wireless phone, a corporation or a third party. Nevertheless, the Supervisor is associated with the supervised wireless phone, as described below.

Restrictions can also be defined with regard to data usage while the phone is at or near defined geographic locations. Separate restrictions can be applied to each type of data service. For example, text messages can be blocked and Internet browsing can be allowed while the phone is within the grounds of a school attended by the user. Additionally, a location restriction can be employed in conjunction with other restrictions on data usage and capabilities described herein. For example, streaming video can be restricted if the wireless phone is within a prescribed geographic region and the time is within a time period specified by the Supervisor.

More specifically, the decision whether to block or permit a data usage can be made as a Boolean function of any of the applicable restrictive or permissive criteria applicable to phone or data usage herein described. The location of the wireless phone can be obtained using cell sector identifiers alone or in combination with signal strength information, a global positioning system receiver disposed within the wireless phone or by any other suitable techniques (alone or in combination) for determining the geographic location of the wireless phone.

In one embodiment, messages to or from predetermined numbers or addresses specified by the Supervisor, and time spent browsing Internet sites specified by the Supervisor, are not counted toward the total number of messages or minutes permitted during the specified control period.

If a supervised user attempts to use a data service during a period in which such use is prohibited, or from a prohibited geographic region, a message can be played or displayed to the user indicating that the attempt will not be honored at that time and/or from that location. Similarly, if a message is sent to a supervised user during a period during which data usage is prohibited or while the wireless device is within a prohibited geographic region, a message can be sent to the originating party indicating that the phone is not accessible at the present time or in the current location.

The Supervisor can also specify telephone numbers, addresses, uniform resource locations (URLs) or identifies of other sources within the user profile that are never permitted to send data to the supervised user's phone, and the system prevents any data from such sources from being delivered to the wireless phone. Additionally, the system can prevent the wireless phone from being used to send data to addresses or other destinations specified by the Supervisor. The data destinations that cannot be reached from the supervised phone and the data source from which data transmissions are blocked are referred to herein as “never-accessible addresses” (or “never-accessible identifiers”).

If voicemail capability is enabled for a supervised user's phone, data, such as text messages announcing new voicemail messages from callers, other than from always-accessible callers, can optionally be blocked.

Certain data sources, namely the always-accessible addresses, can be identified within the user profile and data from these numbers can always access the supervised wireless phone (or voicemail, should the phone not be answered), even during a prohibited use period or in a prohibited use location. For example, a parent's home number, wireless phone number, work or personal e-mail address can be included in the profile, so that the parent is always able to reach the child's phone. Incoming data for a supervised phone is analyzed to determine if the source of the data is one of the always-accessible addresses. If the data source is not on the always-accessible list, the data can be discarded or, alternatively, stored until the mobile phone is no longer prohibited from receiving the data. However, a data source is provided an ability to send data to the supervised wireless phone upon entering a security code, referred to herein as a “cut-through code.” Thus, the Supervisor (or an individual having knowledge of the cut-through code) can access the supervised wireless phone when sending data from a number other than one of the always-accessible numbers via the use of the cut-through code.

The user profiles are maintained within a database that can be modified at any time by the Supervisor. More specifically, the Supervisor can log in over a wide area communications network (such as the Internet) or an other network or combination of networks that permits remote access. The Supervisor can then change usage limits in real time, change, add, delete addresses that are always or never accessible to/by a particular supervised wireless phone, change restricted use times and make all other permitted changes to the respective user profiles. To assure that changes to the respective user profiles managed by the Supervisor can be made by only the Supervisor, a security code is required to be entered and is verified before permitting changes to be made to the managed user profiles under the Supervisor's controls. The presently described supervisory functions can operate independent of billing controls, such as real-time pre-paid billing controls or post-paid billing systems, that can also be applicable to the supervised phone. The information defining the restrictions on phone use can be stored in a separate database or in a common database i.e., a database that also stores billing parameters. Alternatively, the presently described functionality can be provided as an overlay to pre-paid billing controls or other call billing and control systems and can be configured to share resources with such other systems while exercising call control independently of such other systems. The presently described supervisory system can employ one or more servers that operate independent of servers that provide billing functionality, or alternatively, the presently described supervisory system can share server resources while exercising control independent of restrictions pertaining to billing functions.

Thus, the user profiles allow use of wireless phones by children or other supervised users, subject to controls on incoming and/or outgoing data usage specified by the Supervisor.

Other aspects, features and advantages of the presently disclosed system for exercising supervisory control over wireless phone usage will be apparent from the Detailed Description of the Invention that follows.

### BRIEF DESCRIPTION OF THE SEVERAL VIEWS OF THE DRAWINGS

The invention will be more fully understood by reference to the following detailed description of the invention in conjunction with the drawings, of which:

FIG. 1 is a block diagram depicting a system operative in accordance with the present invention;

FIG. 2 is another block diagram depicting a system operative in accordance with the present invention;

FIG. 3 is a flow chart depicting the processing of incoming calls;

FIG. 4 is a flow chart depicting the processing of incoming calls;

FIG. 5 is a flow chart depicting the processing of outgoing calls;

FIG. 6 is a flow chart depicting the processing of outgoing calls;

FIG. 7 is a block diagram depicting another system operative in accordance with the present invention;

FIG. 8 is a block diagram of a profile database according to one embodiment of the present invention;

FIG. 9 is a block diagram of an allowance record of the profile database of FIG. 8; and

FIG. 10 is a block diagram depicting yet another system operative in accordance with the present invention.

### DETAILED DESCRIPTION OF THE INVENTION

U.S. Provisional Patent Application Nos. 60/449,907 and 60/579,854 and U.S. patent application Ser. No. 10/784,611 filed Feb. 25, 2003, Jun. 15, 2004 and Feb. 23, 2004, respectively, all titled “Method and System for Exercising Supervisory Control Over Wireless Phone Usage,” are hereby incorporated by reference herein.

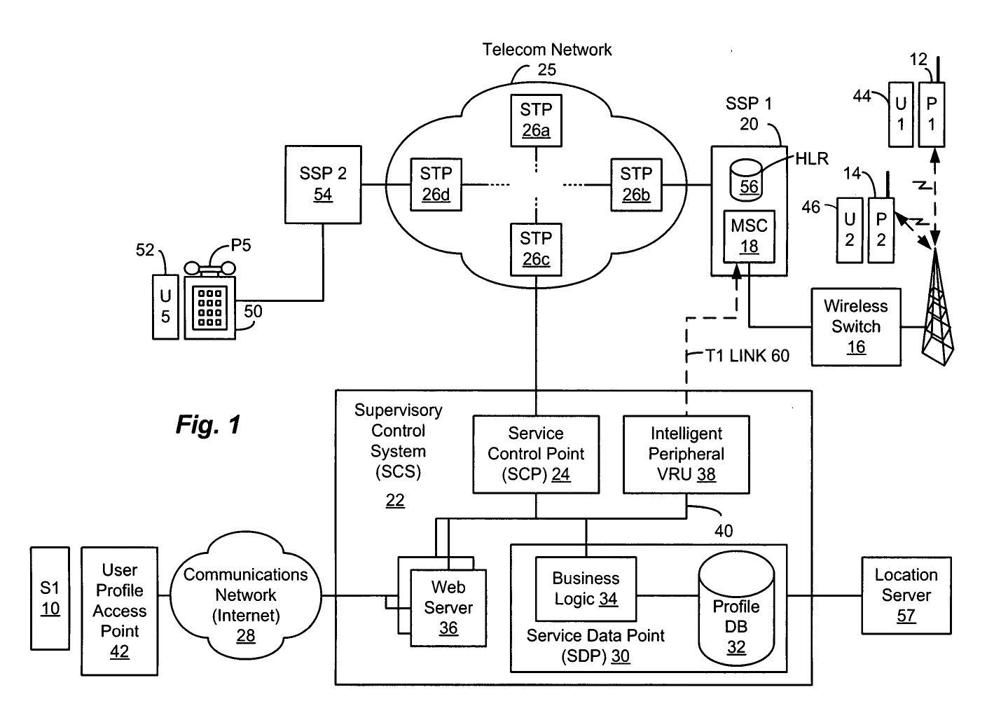

In accordance with the present invention, a system and method for providing Supervisory control over wireless phone usage is disclosed. Some portions of the disclosure relate to wireless phone voice services, other portions relate to wireless phone data services and yet other portions relate to both types of services. Referring to FIG. 1, a Supervisor S1 10, such as a parent or manager, is provided the ability to define a user profile for each of one or more users, such as children or employees. The user profile includes parameters and information that are used to manage phone usage, including data usage. For example, the user profile can specify the total number of minutes the supervised phone can be used during a specified control period, the time of day and/or day of week when incoming and/or outgoing data transmission are prohibited, telephone numbers or other addresses that are never accessible and telephone numbers that are always accessible via the supervised phone, among other controlled characteristics.

Referring to FIG. 1, each wireless phone, shown for purposes of illustration as P1 12 and P2 14, communicates with a wireless switch 16. For purposes of explanation, the wireless switch 16 in the illustrative embodiment can be a switch that is associated with a respective home serving system. The wireless switch 16 is communicably coupled to a Mobile Services Switching Center (MSC) 18 within a Service Switching Point SSP 1 20, which, in turn, is communicably coupled with the presently disclosed Supervisory Control System 22 via a telecommunications network 25, which typically includes a plurality of Signal Transfer Points (STPs) 26a, 26b, 26c, 26d, as known in the art.

The Supervisory Control System 22 includes a Service Control Point (SCP) 24 that communicates with the telecommunications network 25 and performs SS7 signaling, a Service Data Point (SDP) 30 that includes a User Profile Database 32 for storing a user profile associated with each supervised wireless phone subscribed to the presently disclosed service and Business Logic 34 that serves as an intelligent interface between the SCP 24 and the User Profile Database 32. The Business Logic 34 typically comprises a computer that executes software to provide the supervisory processes herein described. The Supervisory Control System 22 further includes a Web-Server 36 that permits accounts to be established in the User Profile Database 32 and updated by Supervisor S1 10, as subsequently discussed. The Supervisory Control System 22 in the illustrated embodiment also includes a co-located Intelligent Peripheral or voice response unit (VRU) 38 that is operative to store and play audible prompts and/or scripts in response to controls issued by the SDP 30. The VRU 38 can alternatively be located geographically proximate to the respective SSP 20, as is known in the art. The SCP 24, Web-Server 36, SDP 30 and VRU 38 in the illustrated embodiment are communicably coupled via a local area network (LAN) 40, such as an Ethernet or any other suitable network. The SCP 24 employs SS7 signaling over the telecommunications network 25 and the SDP 30 executes control software to implement the supervisory control functions herein described.

The Supervisor S1 10, operating through a PC, mobile phone or other Internet enabled access point 42 equipped with a suitable browser, micro-browser or application program, can access the Web-Server 36 via the Internet 28 or another suitable network to establish and modify user profiles for the respective Users U1 44, U2 46.

Control and operation of the presently disclosed Supervisory Control System 22 falls within several areas of functionality, which are listed below:

1. Supervisory Control System service subscription and provisioning;

2. User profile configuration; and

3. Event control.

These functional capabilities are discussed in greater detail below.

1. Supervisory Control System Service Subscription and Provisioning

With continued reference to FIG. 1, the Supervisor S1 10 can create a Supervisory Control System account by accessing the Web-Server 36 within the Supervisory Control System 22 via the Access point 42 or, alternatively, by calling a service representative who enters the applicable account information. A supervisory account identifier is associated with the respective Supervisory Control System account and stored in the User Profile Database 32. Account setup includes the following three functions:

1. Provisioning the Supervisory Control System account within the wireless network;

2. Provisioning the Supervisory Control System account within the billing system so that appropriate charges will be applied with respect to each wireless supervised phone; and

3. Establishing applicable Supervisory Control System parameters for each supervised wireless phone.

More specifically, when creating a Supervisory Control System account via a graphical user interface provided through the Web-Server 36, the Supervisor S1 10 can employ a browser or an application program resident on the access point 42 to access Web pages served by the Web-Server 36 within the Supervisory Control System 22. Alternatively, the Supervisory Control System 22 provides an application programming interface (API) (not shown), and the browser or application program resident on the access point 42 communicates with the Supervisory Control System via this API. Alternatively, the Supervisor S1 10 can place a voice call to a service representative, who enters applicable Supervisory Control System account information. In another alternative, the Supervisor S1 10 calls and interacts with an interactive voice response (IVR) system, rather than or in addition to interacting with a human service representative.

When creating a Supervisory Control System account via the Internet, the Web-Server 36 is accessed via a domain name associated with a carrier and linked to the respective Web-Server 36. The interface provided by the Web-Server 36 guides the Supervisor S1 10 through steps necessary to establish a Supervisory Control System account via one or more interface screens served by the Web-Server 36. Any suitable format for interface screens can be used, as is appropriate for a given implementation, so long as the interface allows the Supervisor S1 10 to establish a Supervisory Control System account and to enter User Profile data applicable to one or more supervised phones.

After accessing the Web-Server 36, the Supervisor S1 10 can log in via the access point 42 using a conventional login registration process. During this login process, the Supervisor S1 10 typically provides a username and an email address. In response, the Web-Server 36 emails a passcode to the specified email address. The Supervisor S1 10 then enters the passcode into an interface screen served by the Web-Server 36 to confirm that the Supervisory Control System account is associated with the proper individual. The supervisory account identifier is associated with the Supervisory Control System account established by the Supervisor.

2. User Profile Configuration

Following the creation of a Supervisory Control System account as described above, the phones to be supervised through the account are identified to the SSP 1 20 so that a determination can be made whether calls or data usage relating to such phones should be processed by the Supervisory Control System 22. Accordingly, the Supervisor S1 10 is requested by the Web-Server 36 to enter a logical phone identifier (which is referred to herein as a Mobile Station Identifier (MSID)) and the Electronic Serial Number (ESN) for each wireless phone in the Supervisory Control System account. The specific Mobile Station Identifier employed can vary from system to system. For example, the MSID can be a Mobile Directory Number (MDN), a Mobile Identification Number (MIN), an International Mobile Subscriber Identity (IMSI), a Mobile Subscriber International Services Directory Number (MSISDN) or any other suitable phone identifier. In the illustrative example, the MSID and the ESN for wireless phones P1 12 and P2 14 shown in FIG. 1, that are to be supervised by the respective Supervisor S1 10, are associated with the Supervisory Control System account. The Supervisor S1 10 also associates a name of each user with the applicable identifier(s) for the respective wireless phones. For example, in the illustrative configuration shown in FIG. 1, the Supervisor S1 10 enters the name User 1 U1 44 in association with wireless phone P1 12 and the name of User 2 U2 in association with wireless phone P2 14. An MSID is used to identify the wireless phone during call processing. As indicated above, the MSID used can vary from system to system and additionally at different points within a given system.

Information and parameters defining restrictions or permissive conditions for each supervised user's phone are stored in the User Profile Database 32. The parameters are employed to control the use of the respective wireless phone or to establish conditions that define when alert or warning messages should be provided with respect to the usage of the supervised phone.

Following the association of the applicable identifier(s) with the respective users, the Web-Server 36 steps the Supervisor S1 10 through a configuration sequence for each user having a phone to be supervised through the Supervisory Control System account. During this process, the Web-Server 36 presents the terms and conditions applicable to the service and requests that the Supervisor S1 10 accept the terms and agree to payment of a predetermined monthly fee for each wireless phone that is subject to control of the Supervisory Control System 22.

The Supervisor S1 10 also enters user profile data to be stored within the User Profile Database 32. The user profile data specifies how the respective wireless phone can be used and characteristics associated with such usage. The user profile data can impose restrictions on the use of a phone associated with the user profile data or, alternatively, can specify that warnings and/or alerts regarding phone usage are to be provided to the User or Supervisor S1 10 without restricting phone use. Such warnings or alerts can indicate that usage restrictions are in effect or provide alerts that pertain to the amount of phone usage.

The user profile data described below corresponds to the data that can be entered for a single user. It should be recognized that the same process is repeated for each user specified by the Supervisor S1 10 within the Supervisory Control System account.

By way of example, and not limitation, the Supervisor S1 10 enters the following information from the access point 42 via a browser interface in response to prompts by the Web-Server 36.

3. Event Control

3a. Overall Usage Limits

The Supervisor S1 10 can optionally specify an overall usage limit for a respective user. The overall usage limit specifies the number of minutes that the wireless phone associated with that user can be used within a predetermined control period, such as a week, a month or any other suitable interval. For example, the predetermined control period can correspond to a weekly or monthly period specified by the Supervisor S1 10, a billing period, a calendar month or any other unit of time, and can be revised from time to time by the Supervisor S1 10 via the Web-Server 36 interface or through a service representative who updates the User Profile Database 32. Once the user of a supervised phone uses a number of minutes equal to the overall usage limit allotted for the control period, no further incoming or outgoing data usage is permitted until the next control period, except for data to or from always-accessible numbers, as discussed below. If the usage limit is set to 0 minutes, the phone is usable only for data traffic to/from always-accessible numbers that are defined by the Supervisor S1 10. As an exception to the restrictions discussed in the preceding two sentences, in the case of incoming data that is sent to a restricted phone using a valid cut-through code as described below, the data is delivered and, in one embodiment, the time associated with accessing (such as viewing or responding to) such data is not assessed against the user's usage limit.

In one embodiment, the time spent sending or receiving data to or from the always-accessible numbers is not applied against the overall usage limit. For example, it can be desirable for a child to be able to send or receive text or other messages to or from by a parent without exhausting the overall usage limit established by the parent. In such event, the Supervisor (parent) can establish a usage limit, however data usage to or from the parent is not applied against the overall usage limit.

3b. Warning Messages and Tones

Even if the Supervisor S1 10 does not establish an overall usage limit for a user, the Supervisor S1 10 can optionally enter an indication in the user profile information that warnings or alerts regarding phone usage should be provided to the user or supervisor after one or more usage thresholds are reached. For example, the Supervisor can specify in the User Profile Database 32 that usage alerts are to be provided after a predetermined number of minutes have been spent conversing over the wireless phone and/or browsing the web and at subsequent intervals. Alternatively or in addition, the alerts can be provided after a predetermined amount of data, such as a predetermined number of bytes of data, has been sent and/or received by the supervised wireless phone. The Supervisory Control System 22 maintains one or more values reflective of the cumulative usage of the wireless device within the control period. For example, separate values can be maintained for voice calls, web browsing time, web browsing data, number of text messages, number of instant messages, number of downloaded files of various types (audio, video, executable, etc.) and number of bytes of downloaded files of various types. From time to time, the Supervisory Control System 22 determines whether the cumulative usage of the wireless device has reached the interval value specified by the Supervisor at which usage alerts are to be provided. During a call or data usage, such usage alert can, for example, be provided to the user in the form of a predetermined tone, voice prompt, screen display, pop-up message, text message, etc., as appropriate. Pre-call or post-call audible warning messages to a user can be injected as an audible script as discussed herein via the VRU 38 or alternatively as text messages via a data bearer service to advise the user of the alert condition.

Additionally, alerts can be generated and forwarded to the Supervisor regarding the usage of the supervised phone in specified increments on a per-usage type basis. More specifically, the Supervisor can specify one or more usage increments (measured in time or amount of data), at which alerts are to be generated for each of the usage types. For example, the Supervisor can establish a usage increment (measured in time) for voice calls. The Supervisor can establish a usage increment (for example, measured in messages) for text or multimedia messages. The Supervisor can also establish usage increments (for example, measured in bytes) for web browsing and for file downloading. The Supervisor can store a value corresponding to each usage increment in the User Profile Database in association with an identifier of the supervised wireless phone. The Supervisory Control System 22 can then determine when the cumulative usage of the wireless device (for any given usage type) within a control period equals the usage increment specified by the Supervisor or is an integral multiple of the usage increment specified by the Supervisor.

An alert message can be generated and forwarded to the Supervisor when any cumulative usage of the wireless phone equals the usage interval (in time or amount of data) specified by the Supervisor or is an integral multiple of the specified usage interval or at any times specified by the Supervisor. The alert can be forwarded to the Supervisor as an audible script, by a text messaging service or alternatively, via email delivery. When forwarding an alert to the Supervisor as an audible script, the message can be communicated to a telephone number specified by the Supervisor and stored in the User Profile Database 32 in association with an identifier for the wireless phone. When forwarding an alert message to the Supervisor as a text message, the text message can be forwarded to the Supervisor at a telephone number specified by the Supervisor and stored in the User Profile Database 32 in association with the wireless phone identifier. When forwarding the alert message to an email address, the message can be forwarded to an email address specified by the Supervisor and stored in the User Profile Database 32 in association with the wireless phone identifier. The alert message can also be communicated to the Supervisory account by the Web Server 36 and accessed by the Supervisor either at the Access Point 42 or via a personal computer, mobile phone, or personal digital assistant (PDA) having access to the Web Server 36. At the beginning of each control period (e.g. each month) the value maintained by the Supervisory Control System 22 pertaining to the cumulative usage of the wireless phone can be reset to reflect no usage of the wireless phone within the new control period.

The above-described alerts can be forwarded to the Supervisor and/or User with or without the imposition of restrictions on the use of the supervised phone.

3c. Permitted/Non-Permitted Usage Periods

Within the user profile data, the Supervisor S1 10 can specify time periods during which phone use is permitted or not permitted and can optionally specify particular types of phone usage (such as voice, web browsing, messaging, file downloading, etc.) that are permitted or not permitted during each period. Whether an embodiment of the disclosed system provides for the specification of prohibited usage times or permitted usage times is a matter of design choice.

By way of example, and with reference to FIG. 1, within the user profile data, the Supervisor S1 10 can specify that User U1 44, who for purposes of illustration is assumed to be a young child, is not permitted to use the supervised wireless phone P1 12 for general usage calls other than between 4 pm and 8 pm on weekdays and between 9 am and 8 pm on weekends and holidays. In addition, the User U1 44 is permitted to send and receive text or other messages only during this time period, and the User is permitted to browse the web only on weekends during the allowed time.

If the overall usage limit for the specified control period is set to 0 minutes for a particular supervised phone, the system permits phone usage only to and from always accessible addresses and, additionally, calls to the supervised phone using a valid cut-through code, as discussed below.

3d. Location Controls

Also within the user profile data, the Supervisor S1 10 can specify one or more geographic locations or geographic areas within which phone use is permitted or not permitted. Whether an embodiment of the disclosed system provides for the specification of prohibited usage locations or geographic areas, or permitted usage locations or geographic areas, is a matter of design choice. The Supervisor can specify the geographic location as a street address and a converter or conversion service, as known in the art, can be employed to resolve the street address into a set of coordinates in a predetermined coordinate system. For example, the street address specified by the Supervisor can be stored in the User Profile Database 32 and converted into latitude and longitude coordinates prior to use. Following conversion of the street address into coordinates represented within the specified coordinate system, the coordinates can be stored within the User Profile Database so that the conversion need not be performed each time a call to or from the respective wireless device is made.

The location of the phone is generated using a global positioning system, cell sector identifiers or any other suitable technique for generating coordinates defining the location of the phone. More specifically, cell sector identifiers can be employed to resolve the geographic location of the wireless phone. The function of determining the geographic location of a wireless phone is performed via the use of a location server 57, also known as a location service broker. Such services are commercially available. One company that offers location service broker services is Apertio Limited, Kingswood, Bristol, United Kingdom and such services are described at www.invergence.co.uk. More specifically, the location service broker is operative to convert cell sector identifiers into a coordinate system such as latitude and longitude for subsequent use.

Alternatively, location information regarding the current location of the supervised wireless phone P1 12 can be obtained through the use of a GPS (Global Positioning System) receiver disposed within the wireless phone.

After determination of the geographic location of the phone, the location of the wireless phone is compared to the geographic location specified in the User Profile Database 32 to determine if a call should proceed. More specifically, the Supervisor can specify a distance between the location specified in the User Profile Database and the location of the wireless phone, within which the location of the wireless phone is deemed to correspond to the location specified by Supervisor. If the location of the wireless phone corresponds to at least one location specified by the Supervisor within the User Profile Database 32, the phone usage can be permitted to be completed or the usage can be prevented, based upon the parameters specified by the Supervisor in the User Profile Database 32, in the event of such a correspondence. By way of example, and with reference to FIG. 1, within the user profile data, the Supervisor S1 10 can specify that User U1 44, who for purposes of illustration is assumed to be a young child, is not permitted to use the supervised wireless phone P1 12 for general usage calls or data when the phone is generally within the geographic area defined by the school grounds of User U1 44.

Any appropriate technique for defining such a restricted area can be used. For example, The Supervisor S1 10 can enter an indication of a restricted address and a radius around the address to define the restricted area.

The present system can be embodied to allow the definition of restricted or permitted phone use locations for incoming calls and/or data, outgoing calls and/or data, or both.

i. Use of Cell Sector Identifiers

The Supervisory Control System 22, in one embodiment, obtains cell sector identifiers and uses the cell sector identifiers alone or in combination with associated signal strength information to obtain the location coordinates of the wireless phone. More specifically, the wireless phone has access to the received radio signal transmission strength at the mobile station radio transceiver (P1, P2). A processor on the wireless phone can execute a script or application that enables the wireless phones to calculate, extract and transmit signal strength measurements to the network via a non-displayable SMS message or via any other suitable protocol. The signal strength data is coupled with the cell sector identifier information and the location area code that can be obtained from the home location register (HLR) 56. The signal strength and cell sector identifier information can then be forwarded to the location server 57 to calculate coordinates of the mobile station. The location server 57 can generate coordinates using the cell sector identifiers alone or in combination with the signal strength information to resolve the wireless phone coordinates with greater accuracy. In particular, the Supervisory Control System 22 communicates the cell sector identifiers and optionally the signal strength information to the commercially available service provider, such as the location server 57, to map cell sector identifiers and signal strength data into coordinates that identify the location of the wireless phone. The location server can also be employed to map street address or other address information entered in the Profile Database by the Supervisor into coordinates that are returned to the Supervisory Control System 22.

It should be recognized that the mapping of street address information to latitude and longitude information can also be performed by the Supervisory Control System 22. In the circumstance in which the mapping is performed by the Supervisory Control System 22, the Supervisory Control System 22 includes the location server 57 functionality.

The Supervisory Control System can include a program that inspects the HLR 56 at specific time intervals, obtains or derives the latitude and longitude of the supervised phone at each such time, and arithmetically derives a speed and/or direction of movement of the supervised phone based upon the location information and the time interval. A speed threshold can be stored by the Supervisor in the User Profile Database 32. If the speed threshold is exceeded, a program within the Supervisory Control System can take such actions as are specified by the Supervisor. For example, the Supervisory Control System can be programmed to forward to the Supervisor S1 10 an audible message communicated to a telephone number specified by the Supervisor, a text message via a data bearer service (such as SMS messaging), or an email message that includes an alert that the respective supervised phone has been detected as having exceeded the specified speed threshold. Additionally, the Supervisory Control System can be programmed to communicate a notice to the Supervisor S1 10 via the Web Server 36 that is posted in association with the Supervisory account and accessible by the Supervisor. Moreover, the Supervisory Control System 22 can be programmed to prevent further incoming or outgoing calls or data or to terminate any call or data usage in progress at the time of the detection of the excessive speed condition.

In the event of an outgoing call or data request by a supervised phone, the network inspects the HLR and identifies the telephone as one being managed by the Supervisory Control System 22. This determination can be made based upon the telephone number, MIN, IP address of the calling party or any other suitable phone identifier. In response to the determination that the phone associated with the respective phone identifier is managed by the Supervisory Control System 22, the network passes call control to the Supervisory Control System 22. The Supervisory Control System 22 looks up the user profile in the User Profile Database 32 for the calling party. Upon ascertaining that there is a location restriction on phone use, the Supervisory Control System 22 sends an inquiry to the HLR to ascertain the location of the calling party. The HLR returns to the Supervisory Control System 22 the cell sector identifier associated with the calling party. In one embodiment, the Supervisory Control System 22 obtains coordinates of the wireless phone using the location server 57 and determines whether the coordinates of the wireless phone correspond to the coordinates corresponding to the address entered into the User Profile Database by the Supervisor.

In another embodiment, the Supervisory Control System 22 compares the cell sector identifier associated with the wireless phone with the locations identified in the User Profile Database 32. More specifically, using a location server, the addresses entered by the Supervisor are mapped into cell sector identifiers. If the cell sector identifier of the wireless phone corresponds to a restricted cell sector identifier identified in the User Profile Database 32, the Supervisory Control System 22 provides appropriate signaling to the control network to prevent the call or data usage from being completed. It should be appreciated that if the cell sector identifier of the wireless phone is forwarded to the Supervisory Control System 22 along with the request for service by the Supervisory Control System 22, a subsequent request for the cell sector identifier can be avoided.

When a call or data usage is requested to a supervised phone, the network inspects the HLR and identifies the supervised phone as one that is managed by the Supervisory Control System 32. In response to this determination, control is passed to the Supervisory Control System 22. The Supervisory Control System 22 looks up the user profile in the User Profile Database 32 for the destination party. Upon ascertaining that there is a location restriction on phone use, the Supervisory Control System 22 sends an inquiry to the HLR to ascertain the location of the called party. The HLR returns to the Supervisory Control System 22 the cell sector identifier(s) associated with the destination party and optionally signal strength information associated with each of the cell sector identifiers as discussed above. The Supervisory Control System 22 then compares the location of the wireless phone to the location specified in the User Profile Database 32. This comparison can involve a comparison of coordinates after resolving the cell sector identifier data into coordinates or alternatively a comparison of cell sector identifiers to determine if the wireless phone is at a location that corresponds to a location specified by the Supervisor in the User Profile Database 32. The Supervisory Control System 22 provides appropriate signaling to the control network to either permit the call or data usage to be connected or to prevent the call or data usage from being completed, based upon the result of the comparison. It should be noted that if the cell sector identifier of the wireless phone is forwarded to the Supervisory Control System 22 along with the request for service by the Supervisory Control System 22, a subsequent request for the cell sector identifier can be avoided.

ii. Use of GPS Coordinates

Alternatively, GPS coordinates can be employed to provide restrictions on phone use for a supervised phone. As discussed above, the Supervisor S1 10 enters into the User Profile Database 32 a physical address or the identification of a location at which the phone use is restricted or permitted, as applicable. The physical address, street address or identification entered into the User Profile Database 32 by the Supervisor S1 10 is converted into coordinates. More specifically, a converter accepts input information in the form entered by the Supervisor and converts such information into coordinates defining the location of the wireless phone. In the instant example, it is assumed that the Supervisor has entered into the User Profile Database 32 an address at which the use of the supervised phone is restricted.

The Supervisory Control System 22 accesses the location server 57 to obtain the geographic coordinates (latitude, longitude description) corresponding to the restricted/permitted use location specified by the Supervisor as an address. The geographic area in which the use of the wireless phone is restricted can be represented by a set of coordinates defining boundaries, as a mathematical description, as a set of coordinates and a radius defining a circular area, or any other suitable way of describing the geographic area within which the phone use is restricted or permitted. While the presently illustrated embodiment utilizes latitude and longitude coordinates to identify the geographic area of interest, any other suitable coordinate system can be employed. The Supervisory Control System 22 stores the coordinates or mathematical description defining the geographic location in which the use of the wireless phone is restricted.

In one embodiment, the location of the wireless phone is deemed to be at the location specified in the User Profile Database, if the coordinates of the wireless phone are within a specified distance of the coordinates corresponding to an address specified in the User Profile Database 32. The specified distance can be input by the Supervisor S1 10 and stored in the User Profile Database 32 or a default distance can be specified which can be modified by the Supervisor S1 10.

In response to an outgoing call or data usage from a managed phone, the HLR associated with the wireless phone identifies the phone as one that is serviced by the Supervisory Control System 22 and passes control to the Supervisory Control System 22. The Supervisory Control System 22 inspects the User Profile Database 32 and identifies the originating phone as one that has one or more restrictions involving locations of use. The Supervisory Control System initiates a network query to obtain GPS coordinates of the handset, which are provided by a GPS receiver contained within the wireless phone. The network query can comprise a query of the wireless phone or any other network element having access to the GPS coordinates of the wireless phone. In response to the network query, the GPS coordinates of the supervised phone are returned to the Supervisory Control System 22.

The coordinates of the wireless phone are then compared by the Supervisory Control System 22 to the restricted area as specified within the User Profile Database 32 to determine if the wireless phone coordinates are within a restricted area. If the coordinates of the wireless phone are within the restricted area, the Supervisory Control System 22 prevents the call or data usage from being completed.

Additionally, the Supervisory Control System 22 can include a program that permits the wireless phone or the network to be queried to ascertain the physical location of the phone in response to the receipt of a control code such as “*” or any other suitable control code entered on the keypad of the wireless phone by the supervised user. Alternatively, the Supervisory Control System 22 can initiate a query to ascertain the location of the supervised phone in response to an inquiry initiated by the Supervisor S1 10. Additionally, the Supervisor can initiate a query to ascertain the location of the wireless phone for one of the supervised Users. The request from the Supervisor can be communicated to the Supervisory Control System 22 from the Supervisor's phone, from the Access Point 42 via the Web Server 36 or via any other communication path. Location information responsive to a request initiated either by the supervised user or the Supervisor can be communicated to the Supervisor audibly via a script played by the VRU 38 to the Supervised User's phone, via text messaging or via email. Prior to communication of the location of the wireless phone to the Supervisor S1 10, a conversion of the wireless phone coordinate data to an address can be performed and address information can be conveyed to the Supervisor instead of coordinate data.

In the circumstance of an incoming call or data usage to a supervised phone, a determination is made whether the call or data usage can be completed as discussed above.

It should be recognized that if the coordinates of the supervised phone are provided along with the request for service by the Supervisory Control System 22, the network query can be avoided.

iii. Combinations of Restrictions or Permissive Use

The location information obtained via a GPS receiver disposed in the wireless phone, or a system that resolves the wireless phone location using cell sector identifiers, can be employed in conjunction with other restrictions and/or permissions to determine whether a call or data usage placed to or from the wireless phone should be completed. For example, Boolean functions of restrictions and/or permissions described herein and the location information can be generated to determine whether a call or data usage should be connected or blocked. More specifically, a location restriction can be employed in conjunction with a time period restriction to prevent the wireless phone from being used for normal calls or data usage, ex., while a child is at school and during the normal school hours of 9 am to 3 pm. Thus, the child could make and receive calls and data while at school before and after the normal school day or while away from the school. Similarly, location restrictions can be employed in conjunction with one or more lists of always-accessible addresses and/or one or more lists of never-accessible addresses to allow or disallow calls or data to or from specific addresses, based upon the location of the supervised wireless phone and the addresses on the lists of always-accessible addresses and/or never-accessible addresses, as applicable. Finally, a determination can be made by the Supervisory Control System 22 whether to complete or block a call or data request based upon a combination of one or more of the wireless phone location, always-accessible or never-accessible addresses, date, day or the week and/or a permitted or restricted time period.

While the restrictions and/or permissions regarding phone usage are entered by the Supervisor S1 10 into the User Profile Database 32 for the respective wireless phone, information representative of the location information stored in the User Profile Database can be downloaded from the User Profile Database 32 to a first memory region within the wireless phone and a determination can be made within the wireless phone whether to connect a call or data request made by the wireless phone user based upon a comparison of the downloaded information to location information generated within the wireless phone. Such a determination can be made using a processor within the wireless phone that executes a software program stored in a second memory region within the phone. The first and second memory regions can be within the same physical memory or different physical memories within the wireless phone. For example, if a supervisor has entered into the respective User Profile Database 32 a restriction on phone use that indicates that the wireless phone can not be used when a student is at school between 9 am and 3 pm, a determination can be made by the processor within the wireless phone whether the phone is at the restricted location and whether the current time is within the specified time period, in which event the call or data usage can be blocked. By making such a determination within the wireless phone rather than at the Supervisory Control System 22, unnecessary network traffic is avoided. It should be recognized that the location information stored within the User Profile Database 32 can comprise conventional street address information, which can be converted to latitude and longitude coordinates prior to communication to the wireless phone. Thus, a comparison of the latitude and longitude coordinates corresponding to the street address entered by the Supervisor S1 10 can be made with respect to the latitude and longitude coordinates obtained from a GPS receiver disposed within the wireless phone and a determination can be made that the wireless phone is at the address specified by the Supervisor if a distance between a location specified by the latitude and longitude associated with the street address and a location specified by the latitude and longitude obtained from a GPS receiver within the wireless phone is less than a predetermined threshold distance. If the wireless phone is determined to be at the address specified in the User Profile Database 32, the call or data usage can be terminated or connected as specified by applicable rules maintained within the User Profile Database 32.

3e. Cut-Through Capability

A Supervisor or other individual that desires to call or send a message to a supervised user's phone (assuming the phone is on and not otherwise in use), can always reach the user's phone, provided that a cut-through code has been established for the respective Supervisor and entered by the Supervisor. More specifically, in one embodiment, in response to prompting by the Web-Server 36, the Supervisor S1 10 can provide a cut-through code that is typically defined as being between n and m numerical characters in length. For example a numeric code between 4 and 6 characters in length can be employed. The cut-through code allows the Supervisor S1 10 to access one or more of the supervised phone(s) during hours or under circumstances in which phone usage is otherwise restricted and when the Supervisor S1 10 is not located at an always-accessible address. The cut-through code is communicated from the access point 42 to the web server 36 via the communications network 28. The web server communicates the cut-through code over a data path to the User Profile Database 32 for storage. The data path can include a computer that forms a component of the business logic 34 and that writes the cut-through code to the User Profile Database 32.

In one embodiment, as a default, the cut-through code is assigned based upon the Supervisor's user name that is communicated from the access point to the User Profile Database 32. For example, if the Supervisor's user name is “abcdef,” the cut-through code would be “222333,” which represent the number keys on a typical phone keypad that correspond to the letters in the username. If the username is “222333,” the cut-through code would be “222333.” By way of further example, if the username is “abc444,” the cut-through code would be “222444.” If the username is more than six characters in length, the cut-through code can be truncated at a predetermined number of characters, such as at six characters. By using the username as the default cut-through code, the necessity to have the Supervisor input this code is avoided. The Supervisor can be permitted to modify the default cut-through code to specify a different cut-through code to provide higher security.

The Supervisor can also convey the cut-through code to an administrator orally, and the administrator can input the cut-through code to the Supervisory Control System 32.

When a Supervisor having knowledge of the cut-through code calls or sends a message or other data to a supervised phone at a time when the use of the phone is subject to a restriction on use, a message is played, displayed or sent to the calling party (the Supervisor) that indicates that the called phone is not accessible. If the Supervisor successfully enters the cut-through code before a predetermined time interval expires, the call or message is allowed to proceed. For example, the VRU 38 can prompt for and accept the Supervisor's inputs (such as DTMF key presses or spoken digits). In another example, the Supervisor sends a short text message (SMS) that contains the cut-through code to the Supervisory Control System 22.

If the cut-through code is not entered or sent within the predetermined time interval, the call or message is blocked. For voice calls, if the call or message is allowed to proceed, a control message of a first type is forwarded to the control network to signal that the call should be connected. If the call is not to be connected, a control message of a second type is forwarded to the control network to prevent the call from being connected.

The “cut-through” capability can be tested during the user profile data setup. At such time, the Supervisor S1 10 can have physical possession of the phones controlled under the Supervisory Control System account before the phones have been distributed to their users. More specifically, in response to prompting from the Web-Server 36, the Supervisor S1 10 powers on the respective user's phone, which is subject to at least one use restriction, and attempts to call it. When the Supervisor S1 10 hears a prompt advising that the phone is not presently reachable, the Supervisor S1 10 enters the previously selected cut-through code. If the cut-through capability is functioning properly, the respective user's phone rings as a result of the entry of the cut-through code.

3f. Always-Accessible Addresses

In response to a prompt from the Web-Server 36, the Supervisor S1 10 can optionally enter a first list of telephone numbers, URLs, or other addresses that can always be accessed by the respective user and a second list of addresses that can always access the respective user's phone, assuming the wireless phone is powered on and reachable within the wireless network. These lists can be provided as separate lists or, alternatively, they can be aggregated into a single list. Optionally, the Supervisor S1 10 can enter or associate within the user profile data short codes that correspond to the always-accessible addresses, so that one or more of the always-accessible addresses can be rapidly called or a message sent thereto in an emergency situation, without the need for a user to remember the address.

3g. Never-Accessible Addresses

In response to a prompt from the Web-Server 36, the Supervisor S1 10 can optionally enter a list comprising one or more addresses or telephone number prefixes that the user of an associated phone should never be able to access and a list of addresses or telephone number prefixes that should never be able to access the supervised user's phone. These lists can be entered as separate lists or, alternatively, they can be aggregated into a single list.

3h. Saving of User Profile Data

When the Supervisor S1 10 initiates the saving of the user profile data, that data is associated with the respective user. If the Supervisor S1 10 exits the setup routine without saving the user profile data, the respective wireless number is provisioned within the Supervisory Control System 22 for unrestricted use.

3i. Setup of Additional Users

The Web-Server 36 can prompt the Supervisor S1 10 to determine whether he/she desires to utilize the same user profile data for the next user that needs to be configured. The Supervisor S1 10 can apply the previously entered user profile data for the setup or the next user or, alternatively, the Supervisor can establish a new user profile for the next user. Moreover, as further discussed below, user profiles can be defined and modified on a user group basis. Under such circumstances, the disclosed system enables the Supervisor S1 10 to define a set of user profile parameters that apply to a group of phones and associated users. The control parameters for the group can subsequently be modified and members of the group added or deleted.

4. Supervisory Control System Operation

4a. Supervisory Control System Operation for Incoming Calls to a User

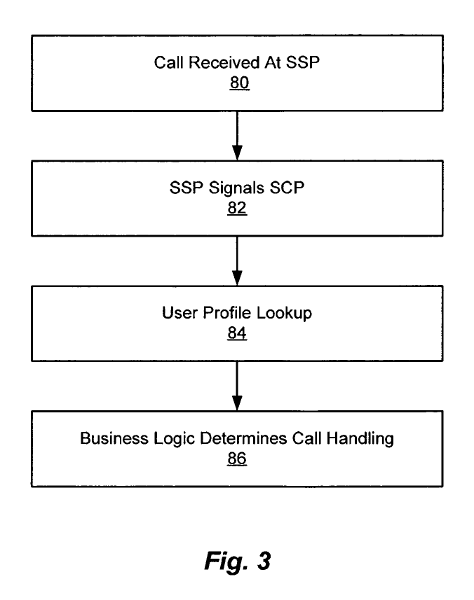

Operation and signaling for the Supervisory Control System 22 with respect to a telephone call that is placed to a user is described below with respect to the devices in FIG. 1 and the steps shown in FIG. 3.

The following example describes an exemplary call from a calling party U5 52 from a telephone P5 50 to a called party U2 46 at a supervised wireless phone P2 14. It is assumed for purposes of the present discussion that Supervisor S1 10 established a user profile applicable to phone P2 14 at a prior time and that the user profile for the phone P2 14 prohibits general phone usage during school hours from 8:00 am to 4:00 pm weekdays.

The call placed by caller U5 52 from phone P5 50 is received at an associated Signal Switching Point (SSP 2) 54 as depicted at step 80 of FIG. 3. The Signal Switching Point (SSP 2) 54 accesses the Dialed Number Identification Service (DNIS), which includes the dialed telephone number for the call. From the DNIS, the SSP identifies the service provider for the dialed phone number and routes the call to the applicable service provider. In the instant example, the call is routed to SSP 1 20, which is within the home serving system for the wireless phone P2 14.

The SSP 1 20 within the home serving system for the called number extracts a MSID from the DNIS. The SSP 1 20 performs a lookup within the Home Location Register (HLR) 56 using the extracted identifier to obtain the HLR record for the respective called wireless phone P2. The HLR record includes data that instructs the respective Signal Switching Point (SSP 1) 20 what to do next. If the HLR record indicates that the Supervisory Control System 22 should be accessed in the event of calls to the respective called party, the Supervisory Control System 22 is signaled. If the HLR 56 does not indicate that the Supervisory Control System 22 should be accessed, the call is connected subject to any other restrictions and protocols that can be applicable.

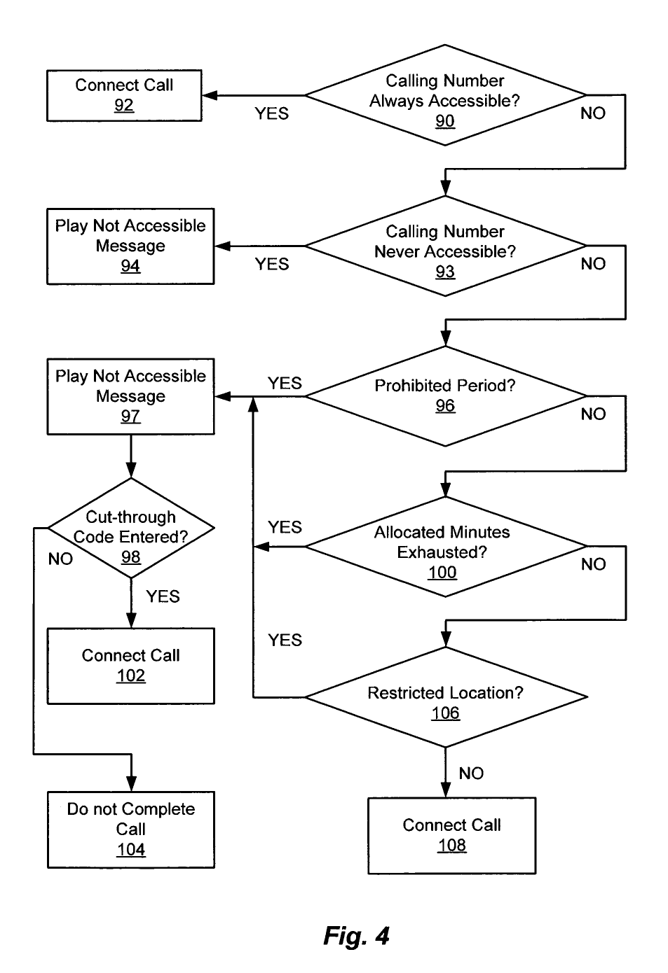

In the instant example, the HLR record includes information that instructs the SSP 1 to signal the Supervisory Control System 22 that an incoming call is pending. More specifically, as depicted at step 82 of FIG. 3, the respective SSP (SSP 1) 20 signals the SCP 24 within the Supervisory Control System 22 that an incoming call is pending for a called party having a specified MSID. The Service Data Point (SDP) 30 within the Supervisory Control System 22 performs a lookup within the User Profile Database 32 as depicted at step 84 of FIG. 3 to ascertain whether the MSID corresponds to a user profile within the User Profile Database. If as a consequence of the lookup, it is determined that the MSID corresponds to an MSID within the User Profile Database 32, the Business Logic 34 executes a software program as shown at step 86 of FIG. 3 to determine how the call should be handled. As a result of the Business Logic 34 processing, the SCP 24 can be instructed to initiate SS7 signaling and a VRU such as VRU 38 can be instructed to play an audible script to a supervised phone or a calling party. More specifically, if the MSID of the called party corresponds to the MSID of a phone within the User Profile Database 32, the Business Logic 34 within the SDP 30 accesses the relevant data within the applicable records of the User Profile Database 32, current conditions, such as time, date, calling number, and called number and determines what action should be taken. Exemplary Supervisory Control System processing under the control of the Business Logic 34 is described below with reference to FIG. 4.

As depicted at step 90 of FIG. 4, the Business Logic 34 determines at step 90 of FIG. 4 whether the calling number corresponds to an always-accessible telephone number that can always be put through to the supervised phone P2 14. If the calling number corresponds to a telephone number that is specified in the User Profile Database 32 as being an always-accessible number that can always access phone P2 14, the SCP 24 within the Supervisory Control System 22 signals the SSP 1 20 associated with the phone P2 14 (in the instant example SSP 1 20) to allow the call to be connected to the phone P2 14 as indicated at step 92. In response, the call is routed through the MSC 18 in SSP 1 20 to P2 14 to establish the desired connection between P5 52 and the supervised wireless phone P2 14.

If the Business Logic 34 determines, as depicted at step 90, that the calling number does not correspond to a number that can always access the respective phone P2 14, the Business Logic 34 next determines whether the calling number corresponds to a number that is identified within the User Profile Database 32 as never being permitted to access the phone P2 14 as depicted at step 93 of FIG. 4. If the Business Logic 34 determines that the calling number is on the list of never-accessible numbers as depicted at step 93, the Business Logic 34, in conjunction with the SCP 24 can cause a connection in the form of a T1 link or any other suitable communication link to be established between the Intelligent Peripheral or Voice Response Unit (VRU) 38 and the MSC 18. The MSC 18 then couples the VRU 38 through to the calling party. An audible message specified by the Business Logic 34 is played to the calling party by the VRU 38 to indicate that the called party is not accessible as depicted at step 94. The SCP 24 then causes the T1 connection between the VRU 38 and the MSC 18 to be torn down and the SCP 24 signals the Signal Switching Point SSP 1 20 to disconnect the call from the calling party.

If the Business Logic 34 determines that the number of the calling party does not correspond to an always-accessible number or a never-accessible number, as depicted at step 96, the Business Logic determines whether the present time is within a period during which general phone usage is prohibited, e.g. between 8:00 am and 4:00 pm on a weekday in the instant example. If the present time is within a prohibited period, the Business Logic 34 causes a connection to be established between the VRU 38 and the calling phone P5 50 and causes the VRU 38 to play a message indicating that the called phone is not accessible at the present time as shown at step 97 of FIG. 4. If a cut-through code is entered within a predetermined time period as depicted in step 98, the Business Logic 34 verifies the cut-through code and the SCP 24 signals the MSC 18 to connect the calling party to the supervised phone P2 14 as shown in step 102 by forwarding a control message of a first type. If the proper cut-through code is not entered within the predetermined time period, the Business Logic 34 causes the SCP 24 to initiate SS7 signaling via a control message of a second type that causes the T1 connection between the VRU 38 and the MSC 18 to be broken and the call to be released as depicted in step 104.

If the Business Logic 34 determines that the present time is not within a time period specified within the respective user profile as a period during which general phone usage is prohibited per step 96, the Business Logic 34 determines whether a limit has been established for the number of minutes the phone can be used within a control period and whether the number of allotted minutes for the applicable control period have been exhausted as depicted at step 100. If the total number of allocated minutes for the control period have been exhausted, the Business Logic 34 in conjunction with the SCP 24 causes a connection to be made between the VRU 38 and the calling party via the MSC 18, and causes a message to be played by the VRU 38 indicating that the called party is not accessible as shown at step 97 of FIG. 4. If a proper cut-through code is entered within a specified time period, the Business Logic 34 causes a control message of a first type to be forwarded to the MSC 18 to signal the MSC 18 that the call should be connected. If the predetermined time period has expired without entry of a proper cut-through code, the Business Logic 34, in conjunction with the SCP 24, causes the connection between the VRU 38 and the MSC 18 to be torn down. The Business Logic 34 also initiates signaling of the MSC 18 via a control message of a second type that indicates that the call should not be completed.

If the Business Logic 34 determines that the allocated minutes for the control period for the called party have not been exhausted, the Business Logic 34 next determines whether the calling party has called the supervised user's phone when the phone happens to be at a geographic location at which the use of the phone is restricted as depicted in step 106. If it is determined in step 106 that the called phone is not at a location at which the use of the phone is restricted, the Business Logic 34 initiates signaling of the MSC 18 to cause the call from the calling party to the supervised user's phone P2 to be connected as depicted at step 108.

If the incoming call is placed to the supervised phone at a time when the supervised phone is at a location at which the use of the phone is restricted, a message can be played to the calling party advising that the called phone is not accessible as discussed above with respect to step 97. If a proper cut-through code is not entered within the predetermined time period, the Business Logic 34 initiates signaling of the MSC 18 to prevent the call from being connected as shown in step 104. Alternatively, if the calling party enters the applicable cut-through code as depicted in step 98, the Business Logic initiates signaling of the MSC 18 to instruct the MSC 18 to connect the call as shown in step 102.

It should be recognized that the order of the above steps can be varied and/or selected types of restrictions can be omitted, without departing from the presently disclosed invention and that the present invention involves the functions that are provided rather than the particular order in which such functions are realized. Additionally, the tests applied by the Business Logic 34 can be tests framed in the context of permissive use of the supervised phone rather than in terms of restrictions on use of the supervised phone. By way of example, the User Profile Database 32 in one embodiment includes parameters that define time intervals during which calls are permitted and/or locations at which calls are permitted. The Business Logic 34 in such embodiment is operative to test the current time to determine if the current time is within a time period during which use of the phone is permitted and/or test the current location to determine if the phone is at a location at which use of the phone is permitted. The Business Logic 34 initiates appropriate signaling to the MSC 18 depending upon the outcome of the comparisons.

Appropriate signaling between the MSC 18 and the Business Logic 34 via the SCP 24 is maintained to update the call usage information so that the number of minutes used by the supervised user within the respective control period does not exceed the total number of minutes allotted for general phone usage within the control period. Thus, the SCP 24, in response to a command from the Business Logic 34 can signal the home serving system MSC 18 to release a call upon a determination that the total minute allotment for the control period has been exhausted or allow the respective call to complete as discussed below. Prior to causing a call to be released due to the exhaustion of the total allotted minutes within the applicable control period, the Supervisory Control System 22 can cause a tone to be injected into the ongoing call between the calling party and the supervised phone to indicate to the respective subscribed user that the call is to be released after a predetermined period. This function can be initiated by the SCP 24, the Business Logic 34, or a combination of both depending upon the design partitioning in a given system. The warning tone can be played by the VRU 38 or injected via any other suitable device.

In an alternative embodiment, even if the total number of minutes used by a supervised user within a control period is exceeded during the pendency of a call, the Supervisory Control System 22 permits the call to continue to its completion by the parties. Subsequent general usage calls are blocked until a new control period commences or until modification of the usage controls within the User Profile Database 32 by the Supervisor S1 10 so as to permit further general usage calls.

4b. Supervisory Control System Operation for Outgoing Calls from a Supervisory Control System Subscriber

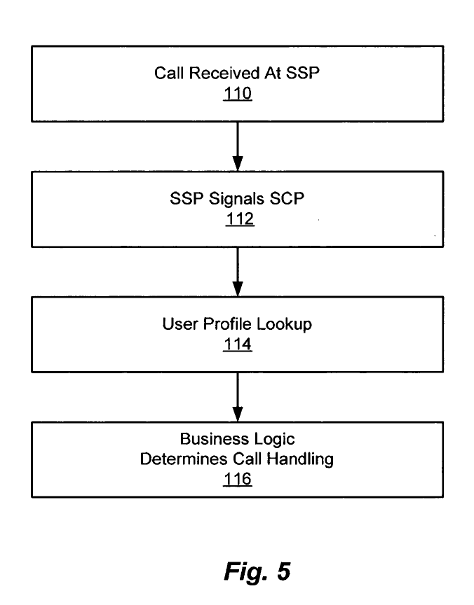

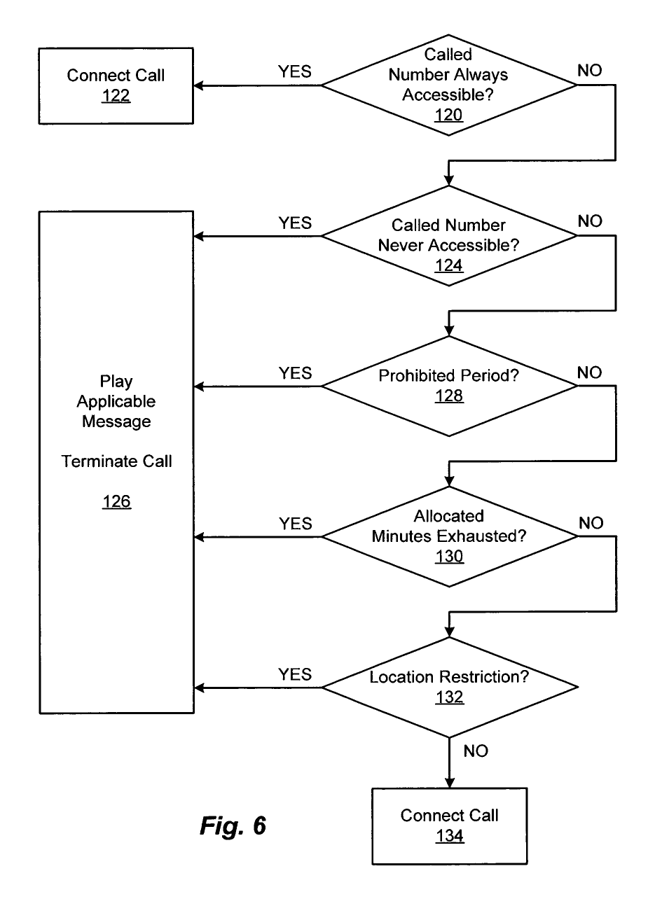

Operation and signaling of the Supervisory Control System 22 with respect to an outgoing telephone call that is placed by a Supervisory Control System 22 subscriber P2 14 is described below with respect to FIG. 1 and flow charts of FIG. 5 and 6. FIG. 1 is employed to illustrate the circumstance in which the wireless supervised phone P2 14 places a call to phone P5 50 that is initially received by the MSC 18 of the home serving system. It is assumed for purposes of the present discussion that Supervisor S1 10 has established a user profile for phone P2 14 and that the user profile for the phone P2 14 prohibits general phone usage during school hours from 8:00 am to 4:00 pm weekdays.

In the instant example, the call is placed by a calling party U2 46 from wireless phone P2 14 to a called party and is received at step 110 of FIG. 5 by the associated MSC 18 in SSP 1 20 as shown. The MSC 18 associated with SSP 1 20 accesses the respective Home Location Register (HLR) 56 and performs a lookup based on an extracted MSID. The HLR 56 contains a record that includes an indication whether service is required by the Supervisory Control System service provider. If an entry in the applicable HLR record indicates that the Supervisory Control System 22 should be signaled to advise of the pending call, SSP 1 20 signals the SCP 24 within the Supervisory Control System 22 to indicate that there is a pending call as depicted at step 112. If the applicable HLR record does not indicate that Supervisory Control System services are required, the call is processed in accordance with conventional call processing protocols.

Once the Supervisory Control System 22 receives a signal indicating that a call is pending from a Supervisory Control System subscriber, the Business Logic 34 within the SDP 30 of the Supervisory Control System 22 executes a program to determine what services and signaling need to be initiated by the Supervisory Control System 22.

More specifically, as depicted at step 114 of FIG. 5, the Business Logic 34 performs a lookup within the User Profile Database 32 to ascertain whether the MSID of the calling party corresponds to an MSID within the User Profile Database 32. If, as a consequence of the lookup, it is determined that the MSID corresponds to an MSID within the User Profile Database 32, the Business Logic 34 executes a program to ascertain how the call should be handled. In particular, if the MSID of the calling party corresponds to the MSID of a phone having a record within the User Profile Database 34, the Business Logic 34 accesses the relevant data within the applicable record of the User Profile Database 32, accesses current state information, such as time, date and calling number, and determines what action should be taken as illustrated at step 116. An exemplary series of steps that can be executed within the Business Logic 34 is described below with reference to FIG. 6.

As shown at step 120 of FIG. 6, the Business Logic 34 determines whether the called number corresponds to an always-accessible telephone number, i.e. a telephone number that can always be accessed by the respective phone P2 14. For example, in the instant example, it is assumed that calls to one or more numbers associated with the Supervisor S1 10 (such as the Supervisor's home and wireless numbers) can always be completed. If the called number corresponds to a telephone number that is specified in the User Profile Database 32 as being always accessible, the Business Logic 34 signals the SCP 24 that the call can be put through as depicted at step 122, and the SCP 24 signals the MSC 18 then associated with the phone P2 14 to allow the call to be connected to the called party. In response, the SSP 1 20 routes the call from phone P2 14 through to the called party to establish the desired connection.

If the Business Logic 34 determines that the called number does not correspond to a number that is always accessible by the phone P2 14, the Business Logic 34 determines whether the called number corresponds to a number that is never permitted to be accessed by the phone P2 14 as illustrated at step 124. This determination is made by obtaining the called number from the DNIS or any other suitable identifier and by comparing the called number to the never-accessible numbers previously entered into the User Profile Database 32 by the Supervisor S1 10. If the Business Logic 34 determines that the called number is on the never-accessible list, the Business Logic 34 can cause a connection to be established between the Intelligent Peripheral or Voice Response Unit (VRU) 38 and the MSC 18 serving the phone P2 14 via a T1 link 60 as shown or via any other suitable communications link. The Business Logic 34 then causes an audible message to be played to the phone P2 14 via the VRU 38 to indicate to the User U2 46 that the called party is not accessible as illustrated at step 126. The Business Logic 34 finally causes the T1 link (or other connection) between the VRU 38 and MSC 18 serving the phone P2 14 to be torn down and causes the SCP 24 to signal the SSP 1 20 to prevent the call from the phone P2 14 to the called number from being connected by forwarding a control message to the SSP 1 20.

If the Business Logic 34 determines that the number of the called party does not correspond to an always-accessible number or a never-accessible number, the Business Logic 34 determines whether the present time is within a period during which general phone usage is prohibited as depicted at step 128, e.g. between 8:00 am and 4:00 pm on a weekday in the instant example. If the present time is within a prohibited period, the Business Logic 34 causes a connection to be established between the VRU 38 and the MSC 18 associated with the calling phone P2 14 and causes the VRU 38 to play a message indicating that the call cannot be connected at the present time. The Business Logic 34 then causes the T1 link 60 between the VRU 38 and the respective SSP 1 20 to be torn down and causes SCP 24 to signal the MSC 18 by forwarding a control message that indicates that the call should be released as shown at step 126.

If the Business Logic 34 determines that the present time is not within a time period specified within the respective user profile as a period during which general phone usage is prohibited, the Business Logic 34 determines whether the total number of allotted minutes for the month have already been exhausted as depicted at step 130. If the total number of minutes have been exhausted, the Business Logic 34 causes a connection to be made between the VRU 38 and the MSC 18 serving the calling phone P2 14, and causes a message to be played by the VRU 38 to the phone P2 14 indicating that the called party is not accessible as illustrated at step 126. The Business Logic 34 then causes the connection between the VRU 38 and the respective MSC 18 to be torn down and initiates signaling by the SCP 24 to have the call from wireless phone P2 14 released by the serving MSC 18.

If the Business Logic 34 determines that the allotment of minutes for the relevant control period have not been exhausted, the Business Logic 34 determines if the calling phone P2 is subject to a location restriction as depicted at step 132 and as specified in the User Profile Database 32. If the supervised user's phone P2 14 is subject to a location restriction, the Business Logic 34 causes a connection to be made between the VRU 38 and the MSC 18 serving the calling phone P2 14, and causes a message to be played by the VRU 38 to the phone P2 14 indicating that the called party is not accessible as illustrated at step 126. The Business Logic 34 then causes the connection between the VRU 38 and the respective MSC 18 to be torn down and initiates signaling by the SCP 24 to have the call from wireless phone P2 14 released by the serving MSC 18.

If the Business Logic 34 determines in step 132 that no location restriction is applicable to the use of the phone P2 14, the Business Logic 34 initiates signaling by the SCP 24 to the respective SSP 1 20 to connect the subscriber's phone P2 14 to the called party as shown at step 134.

It should be recognized that the order of the above steps can be varied and/or selected types of restrictions can be omitted.

4c. Updating of Phone Usage Information

Appropriate signaling between the respective SSP 1 20 and the Supervisory Control System 22 is maintained during a call to update the call usage information so that the total allotment of minutes for general phone usage within the control period is not exceeded unless permitted as specified in the User Profile Database 32. Time monitoring can be performed by the SCP 24, the Business Logic 34, or a combination of both based upon the particular design partitioning for the Supervisory Control System 22. Such time monitoring of call length can be performed by the Supervisory Control System 22 via a signaling path between the SCP 24 and the respective MSC 18 that is maintained while the call is pending. The Supervisory Control System 22 updates the minutes remaining and can cause the SCP 24 to signal the SSP 1 20 associated with the calling party to release the call upon determining that the allotment of minutes for the control period has been exhausted if so specified by the Supervisory Control System 22.

In an alternative embodiment, even if the total number of minutes used by a supervised user within a control period is exceeded during the pendency of a call, the Supervisory Control System 22 permits the call to continue to its completion by the parties. Subsequent general usage calls are blocked until a new control period or modification by the Supervisor S1 10 of the usage controls within the User Profile Database 32 so as to permit further general usage calls.

Other desired supervisory functions can be performed by the Business Logic 34. Signaling between the Supervisory Control System platform 22 and the applicable SSP 1 20 can be accomplished via any suitable signaling technique.

4d. Roaming Scenarios

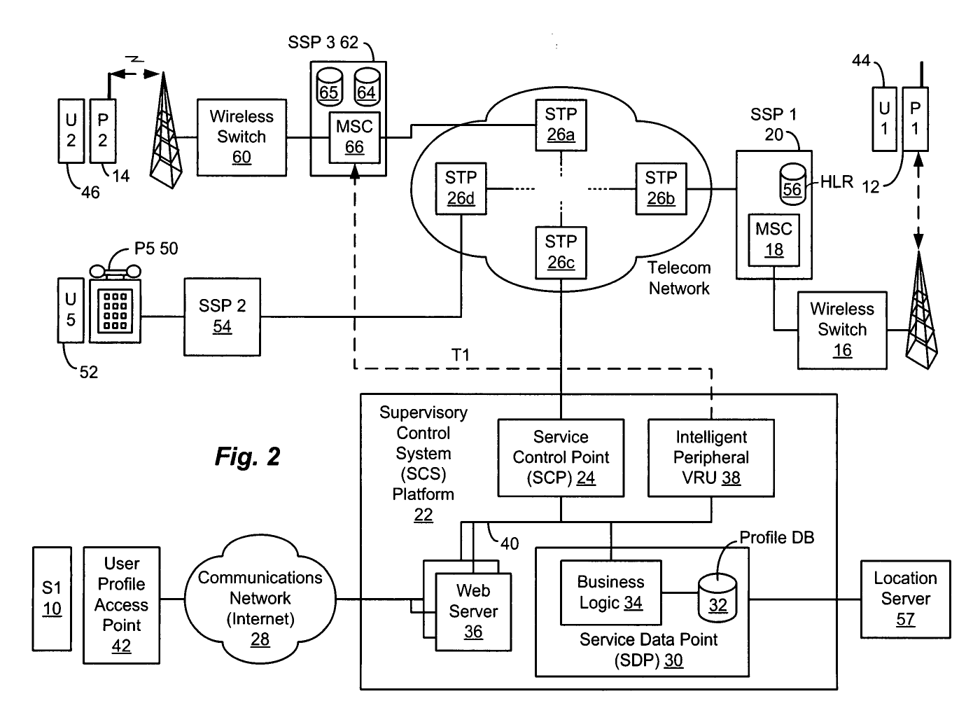

FIG. 2 depicts the circumstance in which a supervised wireless phone is served by an MSC outside the home system. In the instance in which the subscriber U2 46 is roaming, when the subscriber activates the phone P2 14, the MSC 66 accesses a central database 64 using an MSID for the roaming phone to perform a record lookup. The record retrieved from the central database 64 is used to populate the Visitor Location Register (VLR) 65 for the respective MSC 66 as is known in the art. When a call that is placed from the wireless phone P2 is received by the local MSC 66, the MSC 66 uses an MSID associated with the calling wireless phone P2 to perform a lookup within the VLR 65. The record obtained from the VLR includes information instructing the MSC 66 to signal the Supervisory Control System 22 if Supervisory Control System services can be required. Once the SCP 24 within the Supervisory Control System is signaled that Supervisory Control System services are required, processing within the Supervisory Control System 22 proceeds generally as described above, noting that appropriate SS7 signaling is employed as is known in the art for completion, release, and VRU messaging of wireless calls initiated from serving systems other than the home serving system.

Additionally, the Supervisory Control System 22 is invoked with respect to calls received by the supervised phone P2 14 when the phone P2 14 is roaming, noting that appropriate SS7 signaling is employed as is known in the art for completion, release, VRU messaging and tone injection for wireless calls that are received by the supervised phone P2 14.

4e. Enterprise Embodiment

While the preceding examples have described operation of the disclosed system in the context of a parent supervising the wireless phones of children, the disclosed system can similarly be used by a manager within an enterprise to control the usage of wireless phones by employees under his or her supervision. For example, a business organization with a number of employees can be broken down as the following example indicates:
Senior Management—4
Sales—5
Client and Field Support—10

In the present example, 19 phones are available for senior management, sales, and client and field support, collectively, and each employee is to be separately allocated a number of minutes for phone use during the control period. The business does not plan to control usage among Senior Management and Sales employees, but desires to control usage among client and field support employees. Accordingly, the Supervisory Control System account for the business is configured by the responsible manager and the 10 phones provided to the Client and Field Support employees can be treated as a single group of users as further discussed.

The manager navigates to a predetermined Web-site and is prompted to create the necessary Supervisory Control System account. The manager provides his name, company name, service account number for the business, and email address, and creates a login name and password. The manager then defines the wireless phones that are to be controlled under the Supervisory Control System account. The wireless phones under supervision are thus associated with a corporate Supervisory Control System account number for the business. For example, in the case where 10 phones are identified in association with the Supervisory Control System account, an account summary screen can be presented on which an identification of the 10 phones is entered. The manager is then permitted to provision a name next to each of the 10 phones. In one embodiment, by default, the 10 phones are initially setup in a single generic “group” in which they are enabled minimally to call each other. However, though they are initially provisioned to call each other, the manager can further add other names and numbers that the phones should be always available, with respect to calls from and/or to the phones in the initial group, including headquarters numbers, other wireless numbers for employees, etc. Additionally, the manager can establish a specific number of allocated “general purpose” minutes that each phone in the group is allocated to use on a periodic basis. This allocation allows the employee to place calls to other numbers until the allocation has been exhausted. Similarly, a never-accessible list of numbers can be defined for the group. The never-accessible list includes numbers that cannot be the source or destination number for calls involving the respective supervised phone.

At this point, the provisioning process is complete, and the phones are available for use. The manager, for example, is shown an account summary screen, showing the phones as members of a “Default Group”. At a subsequent point in time, the manager can wish to perform management functions with respect to the previously defined Supervisory Control System account. When the manager subsequently logs into the system via the Web server, he or she is again taken to the account summary screen. On the account summary screen, the last view of the managed groups is displayed. For example, an “open” default group folder would be displayed, and a “modify properties” button shown with the 10 phones below it, and showing the MSID, Name, Used/Allocated minutes and a “modify properties” button for each phone. If the manager clicks on the “modify properties” button on for the default group, he or she is enabled to perform the following functions:

(a) Modify the numbers listed under the always-accessible and never-accessible lists, by editing numbers on the lists, and adding or deleting number to or from the lists respectively,

(b) Modify the allocation of minutes for the control period for the group,

(c) Modify any incoming or outgoing call time restrictions associated with the group, and

(d) Modify any other restrictions maintained in the User Profile Database 32 that can be specified by the Supervisor.

When modifying group properties, the modifications take effect for all members of the group. Additionally, the usage properties of the phones can be separately modified. Additionally, where particular messages are specified to be played on the occurrence of certain associated events, such as call blocking, those messages can be defined on a group wide basis. When it is desired to add new phones to the account, for example, when more phones are purchased for new client services employees, the manager can add those phones to the existing group through the Web Server interface after their service is provisioned by the wireless carrier. When the manager logs onto the graphical user interface provided by the Web server 36, the new phones automatically appear as part of the default group, and automatically take on the properties of the default unless the manager “moves” them, for example by a drag-and-drop operation, into another group. The manager is also enabled to define and/or define the name(s) associated with the new phones through the Web Server 36. In this way, multiple user groups can be defined and named with associated use parameters, and users can conveniently be added to and/or moved between the various groups within an Supervisory Control System account.

Additionally, wireless phones of supervised users can include a resident program that permits a client application to be downloaded from the Supervisory Control System 22. For example a Binary Runtime Environment for Wireless (BREW) application that provides a user interface for quick access to the always-accessible numbers they can call, by name, can be downloaded from the Supervisory Control System 22. Such a client application can be configured to connect to the Supervisory Control System 22 at startup to retrieve always-accessible numbers.

In any embodiment, e.g., parent-supervised, manager-supervised, etc., the web server 36 or other user interface to the Supervisory Control System 22 (or 22a, as described below) optionally provides predefined limitations and combinations of limitations (referred to herein as “packages”), from which the supervisor can choose. For example, predefined time limitation packages that are appropriate for children of various ages (such as under 9, 9-12, 13-16, 17-18 and over 18) are defined. An exemplary predefined time limitation package for 9-12 year olds includes allowing voice usage 2 PM to 6 PM weekdays and noon to 6 PM weekends, and allowing Internet browsing (discussed in more detail below) 2 PM to 6 PM weekends. An exemplary predefined time limitation package for 13-16 year olds is more generous.

The user interface for the supervisor can offer separate predefined packages for time, location, allowance, type of access (incoming voice call, outgoing voice call, SMS, short message, web browsing, etc.), always accessible identifiers never-accessible identifiers or other criteria. An exemplary always-accessible identifier list consists of the telephone numbers of the mobile phones that are supervised by a single supervisor or the mobile phones that are billed on a common invoice, such as a “family share” mobile phone service, in which a number of minutes is shared by a set of mobile phones.

Alternatively or in addition, the user interface can offer packages of predefined combinations of time, location, always-accessible identifiers and/or allowance, etc. In any case, the supervisor can choose one or more of these packages and adopt the predefined limitations. Optionally, the supervisor can choose one or more of these packages as a starting point and modify the limitations.

4f. SIM Embodiment

The disclosed system can employ a Subscriber Identity Module (SIM) module within the wireless phone to provide certain filters for outgoing calls from the respective wireless phone under supervision. In such an embodiment, parameters relevant to outgoing call restrictions can be downloaded or otherwise communicated to the SIM within the respective wireless phone from the User Profile Database 32 and can then be stored on and processed using the SIM when an outgoing call is dialed from the respective wireless phone. By way of example, and not limitation, location restrictions, never-accessible number restrictions, time of day restrictions and/or date restrictions specific to the user can be stored within the SIM of the respective wireless phone. In response to the dialing of an outgoing number, the restrictions applicable to the respective phone and stored within the SIM can be tested to determine whether the connection of the call would be contrary to any restrictions. The processing logic associated with this determination can be made by a processor within the SIM or within the wireless phone. Additionally, the parameters defining the use restrictions (or permissive uses) can be stored on a memory within the SIM or alternatively within portions of a memory shared with program code executed by a processor within the wireless handset. By filtering outgoing calls in the above-described manner, network traffic and external processing is reduced since signaling to the Supervisory Control System 22 is avoided and processing pertaining to calls filtered by the SIM need not be performed by the Supervisory Control System 22. The relevant parameters for such outgoing call restrictions can be updated when the phone is powered on and registered within the wireless network to assure that the parameters reflect the current parameters pertaining to use restrictions for the respective wireless phone.

5. System Architecture

The presently described supervisory system can be employed in conjunction with a billing process for wireless phones. For example, call rating data and other parameters applicable to billing functions can be stored in a first database that is used by a first server to perform the billing functions, as known in the art, such as a prepaid billing process for wireless phones.

A second database can be used to store parameters applicable to the presently disclosed supervisory restrictions and a second server executing the presently disclosed supervisory process and including the functions of the Business Logic 34 can be employed to determine whether to connect a call or allow a data usage, in view of the stored supervisory restrictions.

The supervisory process can operate as an overlay to the billing process. For example, in a prepaid wireless environment, a determination can be made whether sufficient funds have been prepaid for the call or data usage to be allowed upon execution of the billing process in the first server. If sufficient funds exist in the prepaid account for a call or data, the supervisory process can then be executed to determine whether the call or data usage should be allowed. It should be understood that the order of execution of the billing process and the supervisory process can be reversed or they can be performed simultaneously. The billing process and the supervisory process can be executed within first and second servers that are separate servers. Alternatively, the first and second servers can comprise the same server and the billing process and the supervisory process can be executed within the same server.

It will be further appreciated by those skilled in the art that while the exemplary embodiments are illustrated in terms of wireless phone communications, the inventive concepts described herein are equally applicable to data usage, including web browsing, messaging services, such as short messaging service (SMS), e-mail, instant messaging and the like, and the presently disclosed concepts can be employed to restrict or permit such communications. With respect to restrictions on data messaging devices, in addition to restrictions applicable to data communication, such as time of day, location, and devices associated with specific individuals, restrictions can be imposed on the number of bytes and/or messages and/or the types of messages and/or data access to be communicated during a control period. The determination whether to permit a data communication to be completed can be made at the Supervisory Control System 22. Additionally or alternatively, determinations whether to restrict data usage can be made using a processor within the wireless device (alone or cooperatively with a central system, such as the Supervisory Control System 22) to reduce network traffic.

6. Profile Database

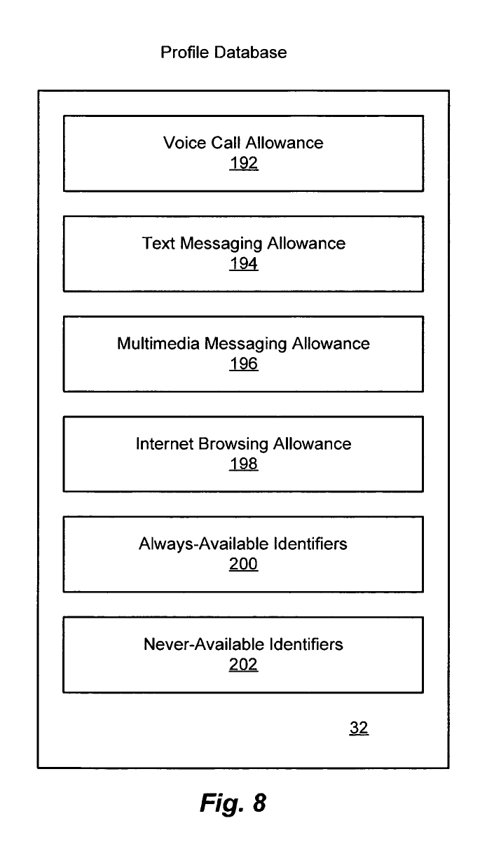

The profile database 32, which has been described above, stores information about limitations the Supervisor places on wireless usage of a managed wireless phone. The limitations can be in terms of the cumulative number of minutes of voice or data phone usage over a control period, a number of sent and/or received messages, a number of sent and/or received bytes, or other appropriate quantitative limitation (collectively herein referred to as an “allowance”). These allowances can be associated with particular data types. For example, one allowance for a user can relate to video, whereas a separate allowance for the user can relate to text. FIG. 8 is a block diagram of one embodiment of the profile database 32 for use in the presently disclosed system. The database 32 contains a plurality of allowances. For example, one allowance can be provided for each type of wireless service that is to be controlled by the Supervisory Control System 22. For purposes of illustration, FIG. 8 shows an exemplary, and non-limiting, profile database 32 that contains a voice call allowance 192, a text messaging allowance 194, a multimedia messaging allowance 196 and an Internet browsing allowance 198. Additional allowances can be included, such as for streaming video and downloading video files, executable programs (such as games), instant messaging and the like.

The profile database of FIG. 8 can also include a set of always-available identifiers 200 and a set of never-available identifiers 202. These identifiers can be telephone numbers, telephone number exchanges, area codes, country codes, SMS addresses, URLs, domains, e-mail addresses or other identifiers to or from which messages can be sent, calls can be placed, Internet browses or downloads can be requested, etc., or portions of such identifiers. In the embodiment shown in FIG. 8, the always-available identifiers 200 and the never-available identifiers 202 are global, i.e. they apply to all the wireless services represented by allowances 192-198. In another embodiment, the always-available identifiers and the never-available identifiers are specific to the respective allowances 192-198 and are, instead, stored with those respective allowances.

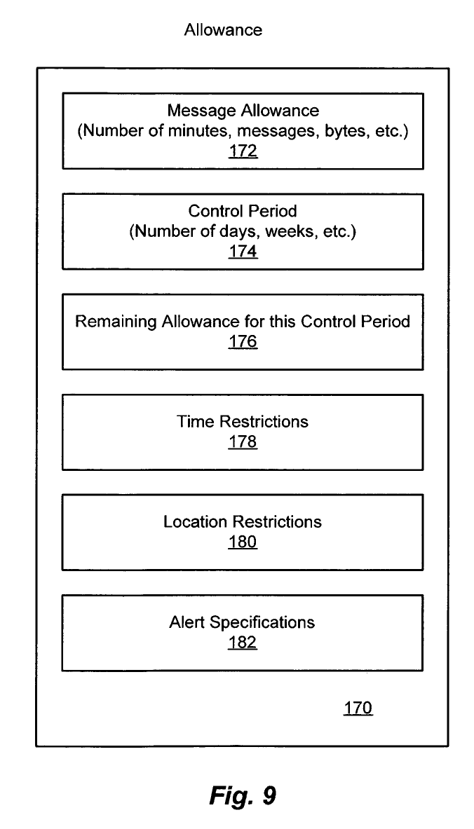

FIG. 9 is a block diagram of an exemplary allowance record 170 of the profile database 32 of FIG. 8. An allowance 172 specifies a number of minutes, messages, bytes or other quantitative measure of usage that a supervised user can use within a control period. A control period 174 specifies an amount of time, such as a number of days, a number of weeks, etc., over which the allowance 172 is available. At the beginning of each control period, the allowance value 172 is copied into a remaining allowance for this control period field 176. As wireless services are used, the remaining allowance field 176 is decremented. Time restrictions, as described above, are stored in a time restrictions field 178. For example, if a user is restricted from using his or her mobile phone between 8 AM and 4 PM, this restriction is reflected in a time restrictions field 178. Similarly, location restrictions, as described above, are stored in a location restrictions field 180. The time restrictions 178 and the location restrictions 180 are shown in FIG. 9 as being allowance-specific, i.e., they are specific to the respective allowances 192-198. Either or both of these restrictions can, however, be global, i.e. they can apply to all allowances stored in the profile database 32. If either or both of these restrictions are global, they are stored once in the profile database (FIG. 8), rather than once for each allowance 192-198.

Alert specifications are stored in a corresponding field 182. For example, if the Supervisor is to be notified after every 30 minutes of telephone use or after every 20 SMS messages, this information is stored in the alerts specifications field 182.

7. Data Usage

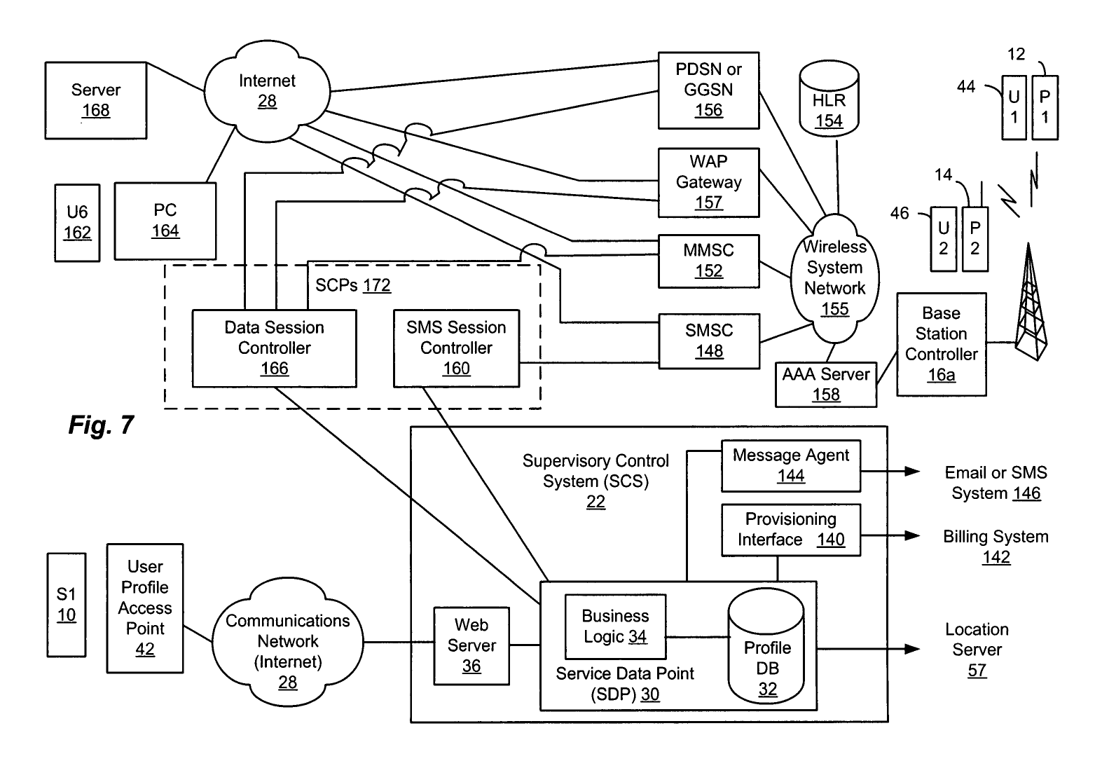

As previously noted, the Supervisory Control System 22 can be used to control data usage by a wireless phone, such as messaging to or from the wireless phone, Internet browsing, file downloading, media (such as audio or video) streaming, etc. Messaging can include text messages, such as short messages (SMSs), multimedia messages (MMSs), e-mail messages, instant messaging and the like. The control of data usage by a wireless phone will now be described with reference to FIG. 7. FIG. 7 is similar to FIG. 1, however FIG. 7 shows a base station controller 16A connected to one or more of the following: a short message system controller (SMSC) 148, a multimedia messaging system controller (MMSC) 152, a wireless access protocol (WAP) gateway 157 and a packet data switching node (PDSN) (if the wireless phone system is a CDMA system) or a gateway GPRS support node (GGSN) (if the wireless phone system is a GSM system) and/or another Internet gateway 156. Other messaging or data controllers or gateways, such as an e-mail gateway (not shown), can be used instead of, or in addition to, the SMSC 148, the MMSC 152, the PDSN or GGSN 156 and the WAP gateway 157.

The base station controller 16A is connected to an MSC (not shown), as in FIG. 1. The base station controller 16A is connected to the SMSC 148, the MMSC 152, the PDSN or GGSN 156 and the WAP gateway 157 via a wireless system network 155. Alternatively, the base station controller 16A is connected to the SMSC 148, the MMSC 152, the PDSN or GGSN 156 and/or the WAP gateway 157 through the MSC (not shown). Optionally, an authentication, authorization and accounting server (AAA server) 158 or another authorization server (not shown) is also connected to the base station controller 16 a via the wireless system network 155, through the MSC (not shown) or otherwise.

The SMSC 148, the MMSC 152, the PDSN or GGSN 156 and the WAP gateway 157 are connected to the Internet 28, as is known in the art. Thus, a user U6 162, using a PC 164, can access a web server (not shown) that permits the user U6 162 to send an SMS message to a mobile phone P2 14 that is controlled by the Supervisory Control System 22. The server formats the SMS message and sends it to the SMSC 148. MMS messages are handled similarly, except the MMSC 152 is involved. The SMSC 148 and the MMSC 152 use the HLR 154 to locate the respective mobile phone P2 14. SMS or MMS messages addressed to the mobile phone P2 14 can also be sent by mobile phones on this or another mobile telephone network. Furthermore, SMS or MMS messages sent by the mobile phone P2 14 are routed through the SMSC 148 or MMSC 152, respectively. Thus, these messages arrive at the SMSC 148 or MMSC 152, as applicable.

The Internet gateway 156 permits a mobile phone P2 14 to browse the Internet 28 and access servers, such as server 168, as is known in the art. Similarly, the WAP gateway 157 permits a mobile phone P2 14 to browse the Internet 28 and access servers, such as server 168, that respond to WAP requests. The Internet gateway 156 also permits the mobile phone P2 14 to download or upload files from or to a server (not shown) on the Internet or to send or receive data, such as according to the FTP protocol or another protocol.

The SMSC 148, the MMSC 152, the Internet gateway 156 and the WAP gateway 157 (collectively also referred to herein as “service gateways”) each communicates with a session controller. For example, the SMSC 148 communicates with a SMS session controller 160. In one embodiment, the SMS session controller 160 provides an XML interface, through which the SMSC 148 communicates with the SMS session controller. This interface can use any suitable protocol, such as HTTP, LDAP, SOAP, TCP, Parlay, Radius, Diameter or TCAP. Alternatively, the SMS session controller 160 can provide a CORBA interface. The PDSN/GGSN 156, the MMSC 152 and the WAP gateway controllers are similarly connected to a data session controller 166. Alternatively, each service gateway can communicate with a separate session controller.

When a data request that involves a wireless phone is made, the system can determine whether the data activity is to be supervised by the Supervisory Control System 22. For example, the service gateways can query the AAA Server 158 or the HLR 154 to make this determination. When a data request made by a supervised wireless phone, such as phone P1 12, or by another entity (such as PC 164) for access to the supervised wireless phone, and the request or its associated data reaches the respective service gateway, the service gateway notifies the respective session controller. The session controller formats a request and sends the request to a service data point 30. The request includes available information about the data access request, such as the source of the request (i.e., the supervised wireless phone or the other entity), the specific identity of the source of the request (such as the telephone number, URL or e-mail address), the type of request (such as web browse, file download request, SMS message, video stream, instant message, etc.), the size of the data request, etc. The information can also include details about the type of message, such as the message's content type, such as text, audio, still image, video clip, etc., the length (e.g. in bytes) of the message or of each piece of a compound message and the protocol(s) used to transmit the data. The type of the data can be inferred from the protocol (such as FTP, HTTP, RTP, etc.) used to transmit the data. Furthermore, the information can indicate a number of message units included in the overall message. For example, a compound message can include any number of text messages, audio clips and/or still images. The information can include other items, such as the time of the requested data usage and the location of the wireless device.

The service data point (SDP) 30 contains business logic 34 and a profile database 32. Based on the information in the request and the phone P1 12 user's profile stored in the database 32, the SDP 30 responds to the request from the session controller to allow or deny the data usage, and the session controller responds to the service gateway to allow or deny the data usage. The SDP 30 ascertains whether the data usage is permitted, according to the respective user's profile, remaining allowance, time restrictions, location restrictions, always-accessible identifiers, never-accessible identifiers, etc. The business logic 34 performs steps similar to steps described with reference to FIGS. 4 and 6 to determine whether the data usage is permitted. If the data usage is permitted, the SDP 30 optionally decrements the appropriate remaining allowance for this control period 176 (FIG. 9) and replies with a first type of message to the respective session controller, indicating that the data usage is permitted. The session controller communicates with the respective service gateway, and the service gateway then passes the data or request to its destination.

Alternatively, the service gateway can treat all wireless phones as being supervised. In this case, the service gateway need not query the AAA server 158 or HLR 154. Instead, the service gateway notifies the respective session controller of each data request. The session controller formats a request, as described above, and sends the request to the service data point 30. The service data point 30 determines if the phone P1 12 is a supervised phone or not. If not, the service data point 30 approves the request. If the phone is a supervised phone, the service data point 30 performs the operations described above to determine whether to approve or disapprove the data request.

In one embodiment, the remaining allowance for this control period 176 is decremented by one for each message, web browse, instant message, file download, etc. Alternatively, the remaining allowance 176 is decremented by the number of bytes in the message, web page, file download, etc. or by another appropriate amount. In one embodiment, compound messages are counted as one message of the primary content type, e.g. text, audio, still image, video, etc. In another embodiment, the user's allowance can be decremented by one message of each of the content types of a compound message. In yet another embodiment, the user's allowance can be decremented by the actual number of messages or bytes of each content type of a compound message.

On the other hand, if the data usage is not permitted, the session controller replies to the respective service gateway with a message of a second type, indicating that the data usage is not permitted. The service gateway then discards the request or data. Thus, the Supervisory Control System 22 can determine whether or not the data or request should be passed onward, based on information provided by the respective service gateway about the data or request, without inspecting the contents of the data.

As discussed hereinabove, if the data usage is not permitted, the Supervisory Control System 22 can send a message to the initiator of the data usage indicating that the original data usage cannot be performed (possibly at this time or in the current location of the wireless phone). In addition, the Supervisory Control System optionally alerts the Supervisor of the attempted data usage. A message agent 144 communicates, such as via SMTP or SMPP, to an e-mail or SMS delivery services platform for delivery of these alerts and other messages, as described above.

If the user U2 46 attempts to browse the Internet 28 with his or her mobile phone P2 14, the browse request is passed by the base station controller 16A to the Internet gateway 156. In one disclosed system, the Internet gateway 156 does not forward the request over the Internet 28 unless the gateway 156 receives approval to do so from a session controller. In another disclosed system, the Internet gateway 156 forwards the browse request over the Internet and communicates with the session controller after the Internet gateway receives all or some of the requested data over the Internet 28, but before the Internet gateway forwards the data to the wireless phone P2 14.

The Internet gateway 156 communicates with the data session controller 166, sending details of the browse request, such as the URL of the requested page and, in the second disclosed system, information (such as the number of bytes, protocol(s), etc., as discussed above) about the retrieved data. The data session controller 166 queries the SDP 30 to ascertain if the browse request or data is permitted, according to the respective user's profile, remaining allowance, time restrictions, location restrictions, always-accessible identifiers, never-accessible identifiers, etc. The business logic 34 performs steps similar to steps described with reference to FIGS. 4 and 6 to determine whether the browse or data is permitted. This decision can be based, for example, on the number of bytes or browses in the remaining allowance for the current control period 176 (FIG. 9). If the browse or data is permitted, the SDP 30 decrements the appropriate remaining allowance for this control period 176 (FIG. 9) and replies to the Internet gateway 156, indicating that the browse is permitted. In the first disclosed system, the Internet gateway then passes the browse request to the web server 168 via the Internet 28. As the browse request is satisfied, i.e. as the Internet gateway 156 receives data from the web server 168, the Internet gateway 156 forwards the data to the wireless phone P2 14 and optionally counts the number of bytes forwarded.

Optionally, after a predetermined number of bytes have been thus received and forwarded, the Internet gateway 156 again sends a request to the data session controller to inform the session controller of the number of bytes forwarded. The session controller again queries the SDP 30 to ascertain if the user's allowance has become exhausted. If the allowance has not yet become exhausted, the SDP 30 decrements the allowance and informs the session controller that the data usage is still permitted. This cycle repeats for every predetermined number of bytes forwarded. On the other hand, if the allowance has become exhausted, the SDP notifies the session controller, and the session controller informs the Internet gateway 156 to end the data session.

Alternatively, when the Internet gateway 156 first notifies the session controller of the Internet browse request, if the SDP 30 indicates that the browse request is permitted, the SDP decrements the allowance by a predetermined amount and notifies the session controller of the amount of data that can be transferred without additional approval. The session controller or the Internet gateway 156 monitors the number of bytes forwarded to the wireless phone P2 14. When the number of bytes transferred exceeds the amount by which the allowance was decremented, the session controller again communicates with the SDP 30. The SDP 30 checks the remaining allowance and, if it is sufficient, the SDP decrements the allowance by the predetermined amount and notifies the session controller of the decremented amount and that continued Internet access is permitted. Optionally, after the browse request is satisfied, if fewer bytes have been transferred than have been decremented from the allowance, the difference is added back to the allowance.

In the second disclosed system, once all or some of the requested data has been received over the Internet 28 and buffered by the Internet gateway 156, but before the data is forwarded to the wireless phone P2 14, the Internet gateway 156 sends information about the data, such as the URL(s), file type(s), number (s) of bytes, etc., to the session controller. The session controller queries the SDP 30, which either permits or denies the data request. If the request is permitted, the SDP 30 decrements the appropriate allowance(s) and the Internet gateway 156 forwards the data to the wireless phone P2 14. Otherwise, if the request is denied, the Internet gateway 156 discards the data.

Thus, the amount of data downloaded from the Internet can be controlled. A similar procedure is used to control the amount of data downloaded or uploaded by the wireless phone P2 14 during WAP sessions, messaging, file transfers and the like.

The session controllers thus perform functions somewhat similar to the service control point 124 of FIG. 1, in that both the session controllers and the service control point receive information about attempted communications involving a managed mobile phone and use the SDP 30 to determine whether such communication should be permitted. Both the service control point 24 and the session controllers send messages to permit or prohibit the communications. Thus, the service control point 24 and the session controllers are sometimes herein referred to herein as control points or service control points. Entities inside dashed box 172 are referred to as control points or service control points (SCPs).

Any combination of the disclosed voice and/or data supervision can be provided. Thus, a system can include a combination of the elements shown in FIGS. 1 and/or 7.

As noted above, when a mobile phone, such as phone P2 14, is provisioned in a wireless telephone network, information about the telephone is stored in the wireless telephone network's HLR. Information is also stored in the wireless telephone network's billing system 142. A provisioning interface 140 provides an interface, such as an XML interface, to the Supervisory Control System 22. Any suitable protocol, such as HTTP, can be used to communicate with the provisioning interface 140. When the phone P2 14 is provisioned, the billing system 142 sends information about the mobile phone's account to the Supervisory Control System through the provisioning interface 140, and this information is stored in the profile database 32.

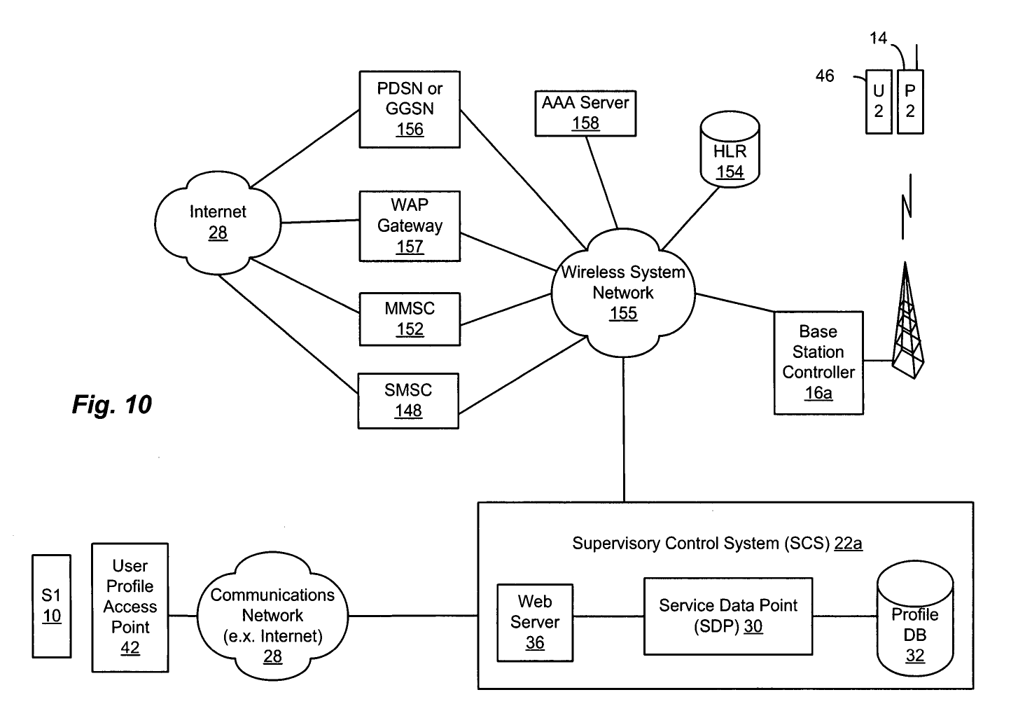

Although a supervisory control system that includes a service data point that receives requests from session controllers has been described, other implementations of such a supervisory control system are possible. For example, an alternative supervisory control system can store a profile database, as described above. However, this system periodically (or according to another schedule) changes class of service information (or other data) in an HLR, AAA server and/or another control mechanism for one or more supervised mobile phones to turn on or turn off each of data service that is controllable by the HLR, AAA server and/or the other control mechanism, according to the profile database. An example of such a system is shown schematically in FIG. 10. A supervisory control system (SCS) 22a includes a web server 36, as discussed above. The SCS 22a includes a service data point (SDP) 30a and a profile database 32, as discussed above, except the SDP 30a communicates with the HLR 154, AAA server 158 and/or another control mechanism (not shown), such as via the wireless telephone system network 155.

In one example, the time restrictions discussed above are defined with a granularity of 15 minutes, i.e. the time periods when mobile phone voice and/or data usage is permitted or prohibited are defined to begin and end on the hour, half hour or quarter hour. Every 15 minutes, the SDP 30a can send information to the HLR 154, AAA server 158 and/or other control mechanism to change data stored therein to enable or disable (as appropriate) data and/or voice access for one or more mobile phones. For example, if a particular user's profile indicates that data access is permitted between 8:30 PM and 10 PM, at 8:30 PM the SDP 30a changes the corresponding mobile phone's data in the HLR, etc. to enable data access by that mobile phone, and at 10 PM the SDP 30a changes the corresponding mobile phone's data in the HLR, etc. to disable data access. This is referred to herein as “pushing” a change to the HLR, etc. By this mechanism, changes to each of the types of voice and data access that is controlled by an entry in the HLR, etc. can be pushed at times dictated by the corresponding user's profile.

In this and the other implementations described herein, a supervisor is associated with one or more wireless communication devices for the purpose of controlling voice and/or data usage by the devices. The supervisor provides, and the system receives, a plurality of preferences regarding limitations on voice and/or data usage by the associated wireless communication devices. For example, the supervisor can specifies a combination of time restrictions (such as disallowing data usage between 8 AM and 2 PM weekdays and between 10 PM and 7 AM everyday.) Alternatively, the supervisor can specify a combination of time and location restrictions, a combination of location restrictions, or other combinations of restrictions. The interface provided by the supervisory control system to the supervisor can accept one or more of these restrictions at a time (such as on one page of a web-based interface). Nevertheless, the system receives the plurality of preferences.

In this and the other implementations described herein, the plurality of preferences received from the supervisor is stored, such as in the profile database. In this and the other implementations described herein, voice and/or data usage by a mobile phone is automatically allowed or disallowed, according to the stored preferences. For example, in the example discussed with reference to FIGS. 1 or 7, for each voice or data usage attempted, the supervisory control system (SCS) receives a request and the SCS allows or disallows the attempt, based, at least in part, on information in the profile database. In the example discussed with reference to FIG. 10, the HLR, etc. allows or disallows the attempt, and the HLR, etc. is kept current by periodic or scheduled updates by the SCS, based on information in the profile database.

Those skilled in the art should readily appreciate that function of the present invention can be performed by one or more processors executing software in the form of computer programs, and programs defining the functions of the present invention can be delivered to a computer in many forms, including, but not limited to: (a) information permanently stored on non-writable storage media (e.g. read only memory devices within a computer such as ROM or CD-ROM disks readable by a computer I/O attachment), or (b) information alterably stored on writable storage media (e.g. floppy disks and hard drives). In addition, while the invention can be embodied in computer software, the functions necessary to implement the invention can alternatively be embodied in part or in whole using hardware components such as Application Specific Integrated Circuits or other hardware, or some combination of hardware components, firmware and/or software.

While the invention is described through the above exemplary embodiments, it will be understood by those of ordinary skill in the art that modification to and variation of the illustrated embodiments can be made without departing from the inventive concepts herein disclosed. Accordingly, the invention should not be viewed as limited except by the scope and spirit of the appended claims.

1. A method of controlling data usage by a wireless communication device, comprising:
associating the wireless communication device with a supervisor;
receiving from the supervisor a plurality of preferences regarding limitations on data usage by the wireless communication device;
storing the received plurality of preferences; and
automatically allowing or disallowing a data usage to or by the wireless communication device according to the stored preferences.

2. The method of claim 1, wherein receiving the plurality of preferences comprises accepting values for the plurality of preferences via a web interface accessible by the supervisor.

3. The method of claim 2, further comprising accepting a new value for at least one of the plurality of preferences from the supervisor via the web interface and storing the new value for the at least one preference.

4. The method of claim 1, wherein receiving the plurality of preferences comprises receiving at least one allowance comprising an allowed amount of data usage for a predetermined period of time; and wherein automatically allowing or disallowing the data usage comprises decrementing the allowance and disallowing the data usage if the remaining allowance is exhausted.

5. The method of claim 4, wherein decrementing the allowance comprises decrementing the allowance by one.

6. The method of claim 4, wherein decrementing the allowance comprises decrementing the allowance by a size of at least a portion of the data usage.

7. The method of claim 4, wherein decrementing the allowance comprises decrementing the allowance by a size of a message.

8. The method of claim 4, wherein decrementing the allowance comprises decrementing the allowance by a size of a file.

9. The method of claim 1, wherein receiving the plurality of preferences comprises receiving at least one geographic restriction; and wherein automatically allowing or disallowing the data usage comprises disallowing the data usage if the wireless communication device is located within a region defined by the geographic restriction.

10. The method of claim 1, wherein receiving the plurality of preferences comprises receiving at least one time restriction; and wherein automatically allowing or disallowing the data usage comprises disallowing the data usage if the data usage is attempted during a time period defined by the time restriction.

11. The method of claim 1, wherein:
receiving the plurality of preferences comprises receiving at least two of:
an allowance comprising an amount of data usage for a predetermined period of time;
a geographic restriction; and
a time restriction; and
allowing or disallowing the data usage comprises allowing or disallowing the data usage based on a logical combination of at least two of the allowance, the geographic restriction and the time restriction.

12. The method of claim 1, wherein automatically allowing or disallowing the data usage comprises allowing or disallowing the data usage without inspecting the contents of the data.

13. The method of claim 1, further comprising:
receiving from the supervisor a plurality of second preferences regarding limitations on voice usage by the wireless communication device; storing the received second plurality of preferences; and
automatically allowing or disallowing a voice usage to or by the wireless communication device according to the stored second preferences.

14. The method of claim 13, wherein receiving the plurality of second preferences comprises accepting values for the plurality of second preferences via a web interface accessible by the supervisor.

15. The method of claim 14, further comprising accepting a new value for at least one of the plurality of second preferences from the supervisor via the web interface and storing the new value for the at least one second preference.

16. The method of claim 13, wherein receiving the plurality of second preferences comprises receiving at least one second allowance comprising an allowed amount of time for a predetermined period of time; and wherein automatically allowing or disallowing the voice usage comprises decrementing the second allowance and disallowing the voice usage if the remaining second allowance is exhausted.

17. The method of claim 16, wherein decrementing the second allowance comprises decrementing the second allowance by one.

18. The method of claim 16, wherein decrementing the second allowance comprises decrementing the second allowance by a length of a telephone call.

19. The method of claim 13, wherein receiving the plurality of second preferences comprises receiving at least one second geographic restriction; and wherein automatically allowing or disallowing the voice usage comprises disallowing the voice usage if the wireless communication device is located within a region defined by the second geographic restriction.

20. The method of claim 13, wherein receiving the plurality of second preferences comprises receiving at least one second time restriction; and wherein automatically allowing or disallowing the voice usage comprises disallowing the voice usage if the voice usage is attempted during a time period defined by the second time restriction.

21. The method of claim, 13 wherein receiving the plurality of second preferences comprises receiving at least two of:
a second allowance comprising an amount of time for a predetermined period of time;
a second geographic restriction; and
a second time restriction.
and wherein allowing or disallowing the voice usage comprises allowing or disallowing the voice usage based on a logical combination of at least two of the second allowance, the second geographic restriction and the second time restriction.

22. A service data point, comprising:
a memory containing a database storing a plurality of supervisor-specified preferences for each of a plurality of wireless communication devices, the preferences being associated with the respective wireless communication devices and related to data usage by the respective associated wireless communication devices; and
business logic connected to the database and operative to:
receive a request related to an attempted data usage by one of the wireless communication devices; and
determine, based on information in the request and the plurality of supervisor-specified preferences associated with the one of the wireless communication devices, whether to permit the attempted data usage.

23. The service data point of claim 22, wherein the business logic is further operative to:
send a control message of a first type if the attempted data usage is permitted; and
send a control message of a second type if the attempted data usage is not permitted.

24. The service data point of claim 22, further comprising an interface for permitting a supervisor who is associated with a subset of the plurality of wireless communication devices to modify the plurality of supervisor-specified preferences for the wireless communication devices associated with the supervisor.

25. The service data point of claim 22, wherein:
the preferences stored in the database include at least one allowance comprising an allowed amount of data usage for a predetermined period of time; and
the business logic is further operative to decrement the allowance and disallow the data usage if the remaining allowance is exhausted.

26. The service data point of claim 25, wherein the business logic is further operative to decrement the allowance by one.

27. The service data point of claim 25, wherein the business logic is further operative to decrement the allowance by a size of at least a portion of the data usage.

28. The service data point of claim 25, wherein the business logic is further operative to decrement the allowance by a size of a message.

29. The service data point of claim 25, wherein the business logic is further operative to decrement the allowance by a size of a file.

30. The service data point of claim 22, wherein:
the preferences stored in the database include at least one geographic restriction; and
the business logic is further operative to disallow the data usage if a wireless communication device associated with the geographic restriction is located within a region defined by the geographic restriction.

31. The service data point of claim 22, wherein:
the preferences stored in the database include at least one time restriction; and
the business logic is further operative to disallow a data usage during the time restriction by a wireless communication device associated with the time restriction.

32. The service data point of claim 22, wherein:
the preferences stored in the database include at least two of:
an allowance comprising an amount of data usage for a predetermined period of time;
a geographic restriction; and
a time restriction; and
the business logic is further operative to determine whether to permit the attempted data usage, based on a logical combination of the allowance, the geographic restriction and the time restriction.

33. The service data point of claim 22, wherein the business logic is operative to determine whether to permit the attempted data usage without inspecting the contents of the data.

34. The method of claim 22, wherein:
the database also stores a plurality of second supervisor-specified preferences for each of at least some of the plurality of wireless communication devices, the second preferences being associated with the respective at least some of the wireless communication devices and relate to voice usage by the respective at least some of the associated wireless communication devices;
the business logic is further operative to:
receive a request related to an attempted voice usage by one of the wireless communication devices; and
determine, based on information in the request and the plurality of supervisor-specified second preferences associated with the one of the wireless communication devices, whether to permit the attempted voice usage.

35. The service data point of claim 34, wherein the business logic is further operative to:
send a control message of a first type if the attempted voice usage is permitted; and
send a control message of a second type if the attempted voice usage is not permitted.

36. The service data point of claim 34, wherein the interface permits a supervisor who is associated with a subset of the plurality of wireless communication devices to modify the plurality of supervisor-specified second preferences for the wireless communication devices associated with the supervisor.

37. The service data point of claim 34, wherein:
the second preferences stored in the database include at least one second allowance for voice usage during a predetermined period of time; and
the business logic is further operative to decrement the second allowance and disallow the voice usage if the remaining second allowance is exhausted.

38. The service data point of claim 37, wherein the business logic is further operative to decrement the second allowance by one.

39. The service data point of claim 37, wherein the business logic is further operative to decrement the second allowance by a length of a voice call.

40. The service data point of claim 34, wherein:
the second preferences stored in the database include at least one second geographic restriction; and
the business logic is further operative to disallow the voice usage if a wireless communication device associated with the second geographic restriction is located within a region defined by the second geographic restriction.

41. The service data point of claim 34, wherein:
the second preferences stored in the database include at least one second time restriction; and
the business logic is further operative to disallow a voice usage by a wireless communication device associated with the second time restriction during a time represented by the second time restriction.

42. The service data point of claim 34, wherein:
the second preferences stored in the database include at least two of:
a second allowance an allowed amount of time for voice usage during a predetermined period of time;
a second geographic restriction; and
a second time restriction; and
the business logic is further operative to determine whether to permit the attempted voice usage, based on a logical combination of the second allowance, the second geographic restriction and the second time restriction.

43. A computer-based system for controlling use of a plurality of wireless communication devices, comprising:
a memory storing a database comprising a plurality of records, each record being associated with at least one of said wireless communication devices and storing an associated plurality of parameters, each parameter defining a restriction governing use of said associated wireless communication device to engage in a data usage;
a web interface configured to enable an account supervisor associated with a subset of said plurality of records to modify said plurality of parameters of said subset of said plurality of records; and
a control point operable to:
receive a notification of an attempt to engage in a data usage with one of said plurality of wireless communication devices;
determine, based on said plurality of parameters associated with said one of said plurality of wireless communication devices, whether to permit said attempt to engage in said data usage; and
generate a control message of a first type if said attempt is to be permitted and generate a control message of a second type if said attempt is not to be permitted.
